(19) United States
(12) Patent Application Publication
(10) Pub. No.: US 2022/0366369 A1
(43) Pub. Date: Nov. 17, 2022

(54) DELIVERY FLEET MANAGEMENT

(71) Applicant: Motional AD LLC, Boston, MA (US)

(72) Inventors: Eryk Brian Nice, Medford, MA (US); Paul Schmitt, Merrimack, NH (US); Moira Doherty, Charlestown, MA (US); Shaurya Agarwal, Boston, MA (US); Sanghee Shin, Seoul (KR)

(21) Appl. No.: 17/746,465

(22) Filed: May 17, 2022

Related U.S. Application Data
(60) Provisional application No. 63/189,613, filed on May 17, 2021.
(60) Provisional application No. 63/189,932, filed on May 18, 2021.

(51) Int. Cl. G06Q 10/08; G08G 1/00

(52) U.S. Cl. CPC G06Q 10/08355; G08G 1/20; G06Q 50/30

(57) ABSTRACT

Provided are methods for delivery fleet management. The method includes obtaining, with at least one processor, at least one delivery factor. The method includes determining, with the at least one processor, delivery options associated with a delivery. The method also includes implementing, with the at least one processor, the delivery option associated with in view of the delivery factors. Systems and computer program products are also provided.

### CROSS REFERENCE TO RELATED APPLICATIONS

This application claims priority to U.S. Provisional Patent Application No. 63/189,932 filed May 18, 2021 and U.S. Provisional Patent Application No. 63/189,613 filed May 17, 2021, the entire contents of which are incorporated herein by reference.

### BACKGROUND

Fleet management includes management of a group of vehicles that provide transportation services. Transportation services refer to the movement of goods or people from one location to another location. Transportation services encompass infrastructure, vehicles, and operations that enable the movement of goods or people. Fleet management coordinates movement in view of the available infrastructure, vehicles, and established operations.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIGS. 5A-5C are diagrams of implementations of delivery fleet management;

FIG. 6 is an example of a predefined map;

FIG. 7 is an example of a decoupled operation of an autonomous driving vehicle and human delivery worker.

FIG. 8 is an illustration of exemplary cases.

FIG. 9 is an exemplary process for fleet management.

FIGS. 10A and 10B are examples of delivery schema.

FIG. 11 is an exemplary process for fleet management.

FIGS. 12-17 illustrate decision criteria.

FIG. 18 is a process flow diagram of a process for delivery fleet management.

FIG. 19 is a process flow diagram of a process for delivery fleet management with ride requests.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein enable delivery fleet management. In embodiments, at least one delivery factor is obtained. For example, for dedicated delivery fleets a delivery factor may include a building type or accessibility type (e.g., area on a predetermined map). For example, for ride hailing fleets a delivery factor may include a state. In embodiments, delivery options associated with the delivery are determined. For example, delivery options for a dedicated delivery fleet includes cases. For example, delivery options for a ride hailing fleet includes decision criteria associated with the delivery. In embodiments, the delivery option associated with the delivery factors is implemented. For example, for a dedicated delivery fleet the case may change based on building/accessibility type. For example, for a ride hailing fleet the decision criteria may change according to the state.

By virtue of the implementation of systems, methods, and computer program products described herein, movement between delivery agents, vehicles, and packages is decoupled. The decoupling of the movement enables the generation of more diffused, efficient and optimized respective routes for each of the delivery agents, vehicles, and packages.

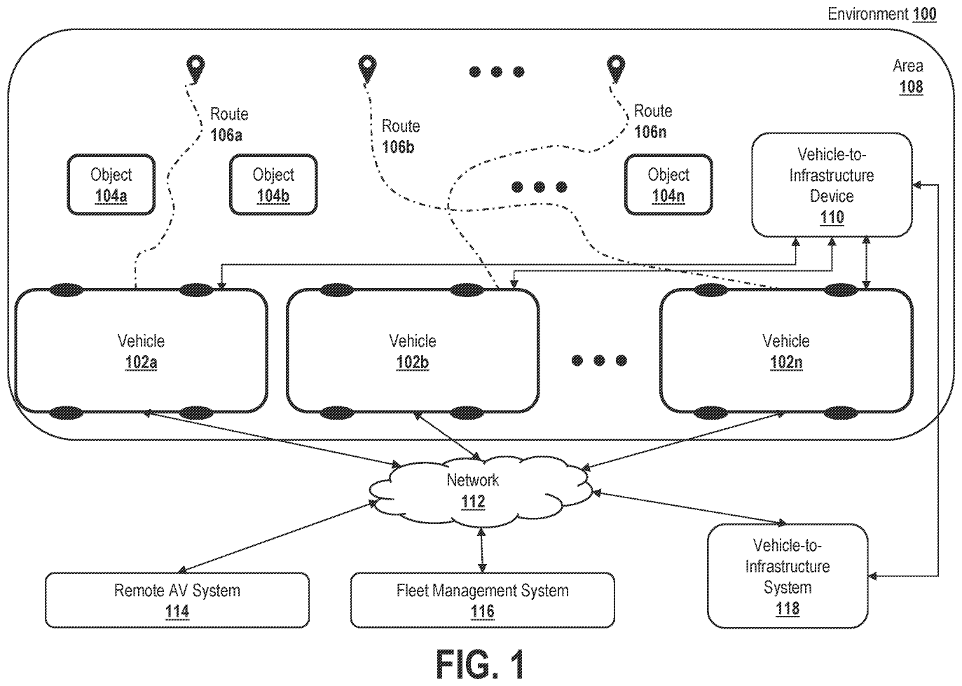

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

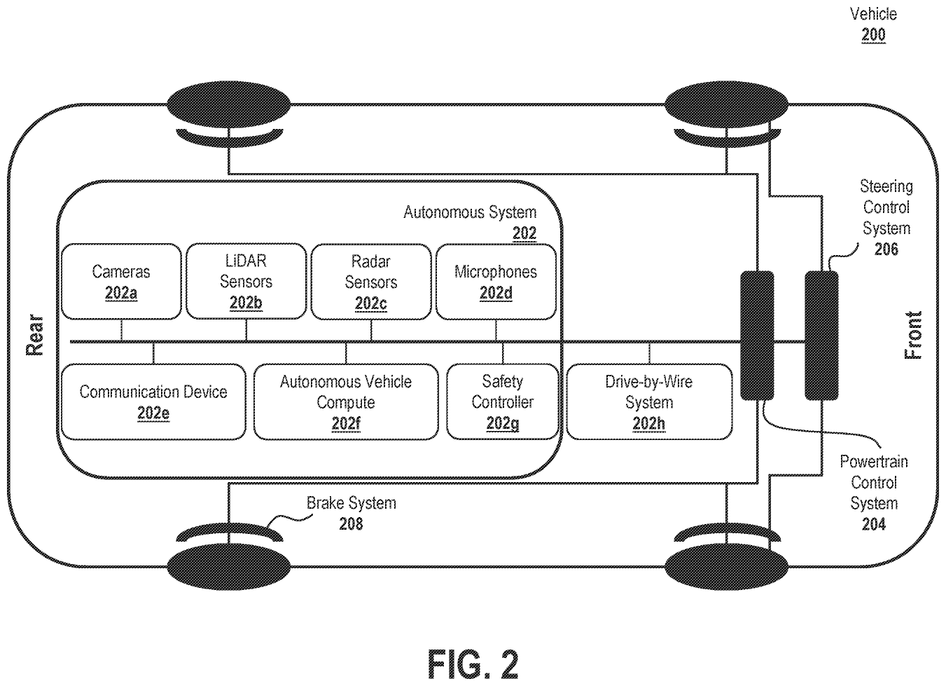

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

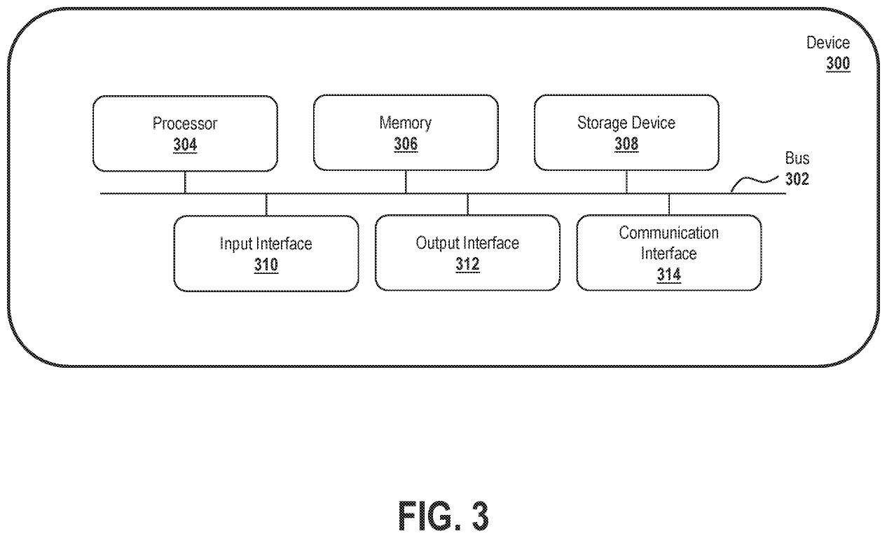

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In some embodiments, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

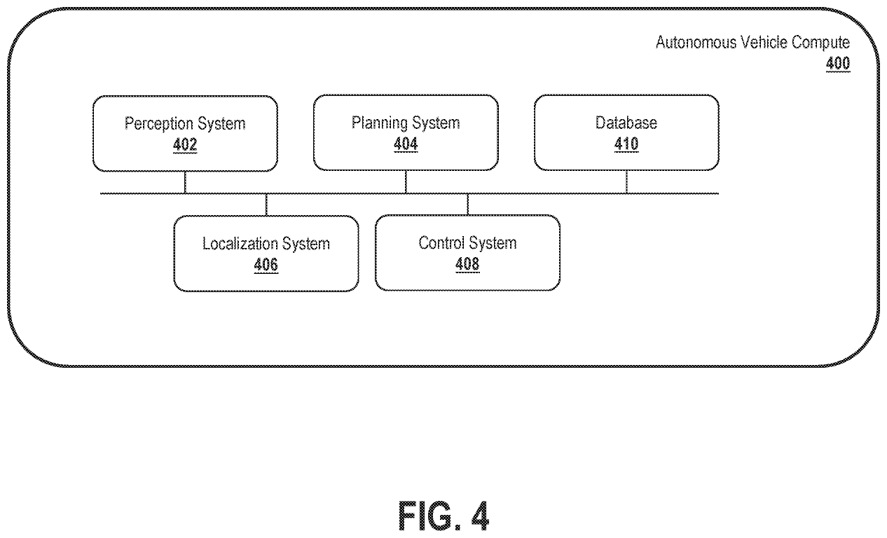

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

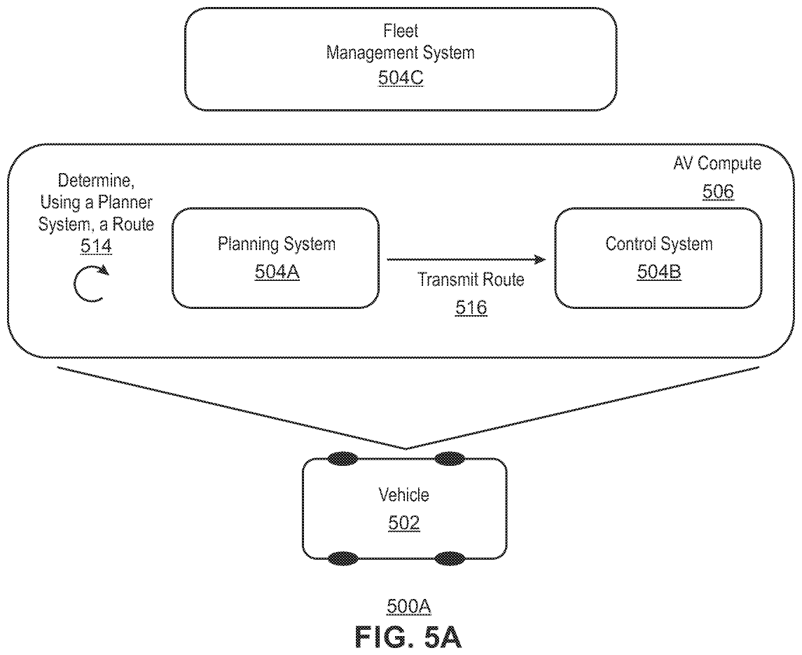

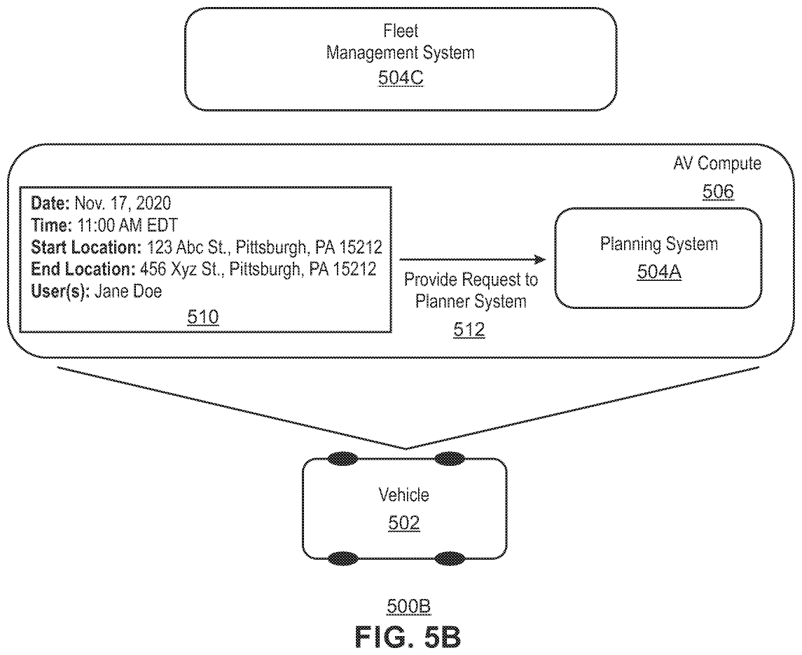

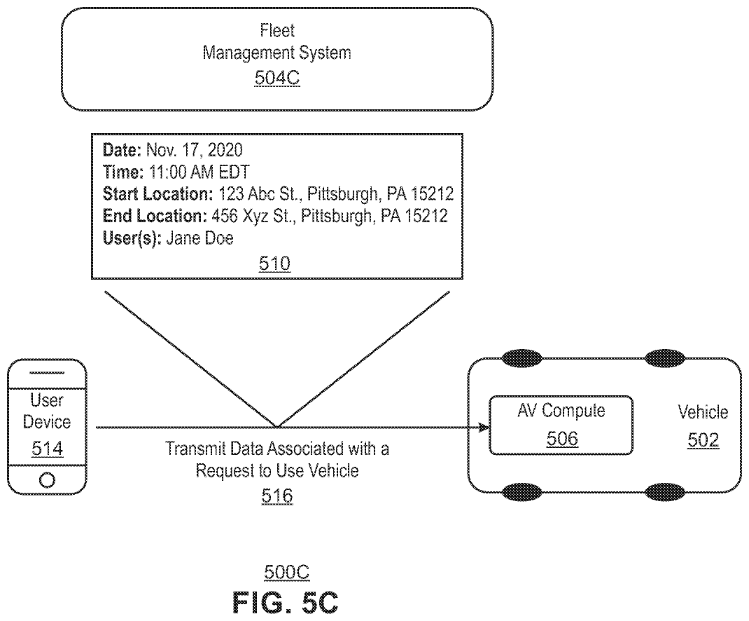

Referring now to FIGS. 5A-5C, illustrated are diagrams of implementations of fleet management. Fleet management includes support and coordination of the operations of a plurality of vehicles. In examples, the fleet management is executed by a fleet management system 116 of FIG. 1. The vehicles may be, for example, vehicles 102 of FIG. 1. In examples, the fleet of vehicles is a delivery fleet of vehicles. A delivery fleet includes vehicles that have a primary purpose of delivering packages to a client. For ease of description, the subject of the delivery is generally referred to as a package, parcel, item, order, and the like. These terms are used to refer to what is being delivered, but should not be viewed as limiting. In examples, when an item is purchased from a merchant, the item travels from a warehouse or other storage facility, through sorting facilities or other logistic centers, to the client. During the movement of the item from a starting location to a delivery location specified by the client, the item is packaged or otherwise prepared for delivery. Depending on the implementation, the client can retrieve the package from a staffed endpoint, the client's curbside or the client's doorstep. In examples, the fleet of vehicles is a ride-hailing fleet of vehicles. A ride-hailing fleet includes vehicles that have a primary purpose of transporting persons from a first location to a second location. For example, a client requests transport from a starting location (e.g., pickup location) to and ending location (e.g., destination). In some embodiments, a ride-hailing service matches potential clients with vehicles for hire. In examples, a fleet may be a mixed fleet of vehicles, including both dedicated delivery vehicles and ride-hailing vehicles capable of performing deliveries.

FIG. 5A is an implementation 500A of delivery fleet management. In the implementation 500A, a vehicle 502 includes an autonomous vehicle compute 506. In examples, the autonomous vehicle compute 506 is the autonomous vehicle compute 400 described in reference to FIG. 4. The autonomous vehicle compute 506 includes a planning system 504A and a control system 504B. In some embodiments, the planning system 504A determines a route based on locations of packages obtained for delivery to one or more clients. In some examples, the planning system 504A transmits or receives data associated with routes for the delivery of packages to one or more clients. For example, the planning system 504A receives data indicating a planned route from a fleet management system 504C based on delivery locations of packages. In some embodiments, fleet management system receives a delivery request and generates routes based on the delivery request, where the delivery request includes a delivery location of a package. In some examples, the fleet management system 504C determines a route in real time based on changes in the packages scheduled for delivery (e.g., reverse logistics). The route is transmitted (516) to the control system 504B. In examples, the control system 504B is the control system 204 described in reference to FIG. 2. The control system 504B transmits signals that cause movement of the vehicle 502 according to the received route.

FIG. 5B is an implementation 500B of fleet management with ride hailing. In the implementation 500B, the vehicle 502 includes the autonomous vehicle compute 506 and planning system 504A, similar to the implementation 500A of FIG. 5A. The autonomous vehicle compute 506 obtains a ride request 510. For example, the autonomous vehicle compute 506 is in communication with a fleet management system 504C. The fleet management system 504 coordinates routes across a plurality of vehicles, and identifies vehicle 502 as available to complete the ride request 510. In some embodiments, ride requests are received (e.g., ride hailing) at the fleet management system 504C, and the fleet management system 504C determines a respective vehicle of the plurality of vehicles to complete the ride request. The fleet management system transmits the ride request 510 to the AV compute 506. The ride request 510 includes a starting location and an ending location for transportation of a client Jane Doe. In the example of FIG. 5B, the ride request is provided (512) to the planning system 504A, and the vehicle 502 completes the ride request. In some embodiments, a cargo area of the vehicle is used for the delivery of packages during execution of the ride request. In examples, execution of a ride request refers to a vehicle providing transportation services as identified in the ride request. For example, the vehicle navigates from the starting location to the ending location as identified in the ride request.

FIG. 5C is an implementation 500C of fleet management with ride hailing via a user device 514. The implementation 500C is similar to the implementation 500B described in reference to FIG. 5B. Accordingly, the vehicle 502 includes the autonomous vehicle compute 506. In the implementation 500C, a client generates a ride request at the user device 514. The user device 514 transmits (516) data associated with the ride request to the AV compute 506 of the vehicle 502. In examples, the AV compute 506 includes a fleet management system 504C that determines if the vehicle is available for execution of the ride request.

As illustrated in FIGS. 5A-5C, fleet management assigns vehicles to routes based on delivery requests, ride requests, or a combination of delivery requests and ride requests. For example, vehicles are assigned routes associated with package delivery or routes associated with ride requests, alone or in combination. Fleet management is based on a map that identifies real world locations, the attributes of buildings at respective locations, and infrastructure associated with the respective locations. Understanding which areas can be serviced by a personal delivery device and which areas cannot be serviced by a personal delivery device is a function of various attributes. The attributes may be, for example, determining if there is a fence (e.g., determining if a fence type obstacle must be passed through to deliver the package), if there are stairs present (e.g., determining if a stairs type obstacle must be traversed through to deliver the package), if a delivery lobby is blocked (e.g., determining if a lobby type obstacle must be passed through to deliver the package, including but not limited to using a phone or other communication method to access the delivery lobby), or if other communications are needed to access a location. In some embodiments, vehicles with differing levels of autonomy or capabilities are used for last mile delivery. Last mile delivery includes the movement of packages from a centralized location to the delivery location. In examples, the delivery location is a personal residence and last mile delivery refers to a final step in transporting packages. Objectives of last mile logistics include to deliver goods to the client as fast as possible, and to deliver the goods as efficiently as possible, sometimes at the expense of speed.

In some embodiments, one or more locations are described in terms of an ability of the location to be serviced by automation (e.g., predefined map). The present techniques determine which areas can be serviced by automation, which areas are difficult to be serviced by automation (and to separate these areas from other areas), and which areas do not require automation to complete the delivery (for example, there is infrastructure available on the receiving end that can receive the delivery).

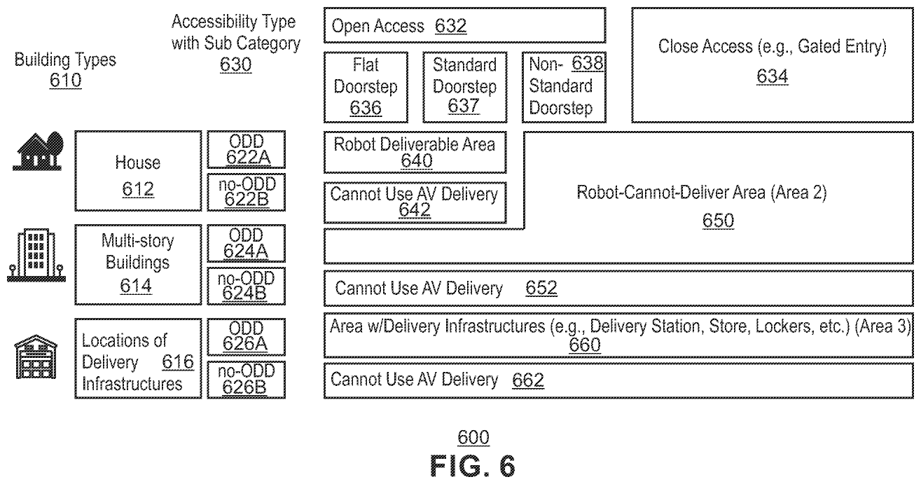

FIG. 6 shows a predefined map 600 that enables delivery fleet management. The predefined map 600 characterizes physical locations in the real world. In some embodiments, a fleet management system 504C as described with respect to FIGS. 5A-5C generates and assigns routes to vehicles of a fleet based on attributes of buildings at respective locations of the predefined map 600.

As shown in FIG. 6, building types 610 are illustrated for locations of the predefined map 610. The building types 610 include houses 612, multistory buildings 614, and delivery infrastructure locations 616. The building types 610 are for exemplary purposes only and should not be viewed as limiting. In some embodiments, the building types 610 identified in the predefined map 600 include more or fewer building types than those described.

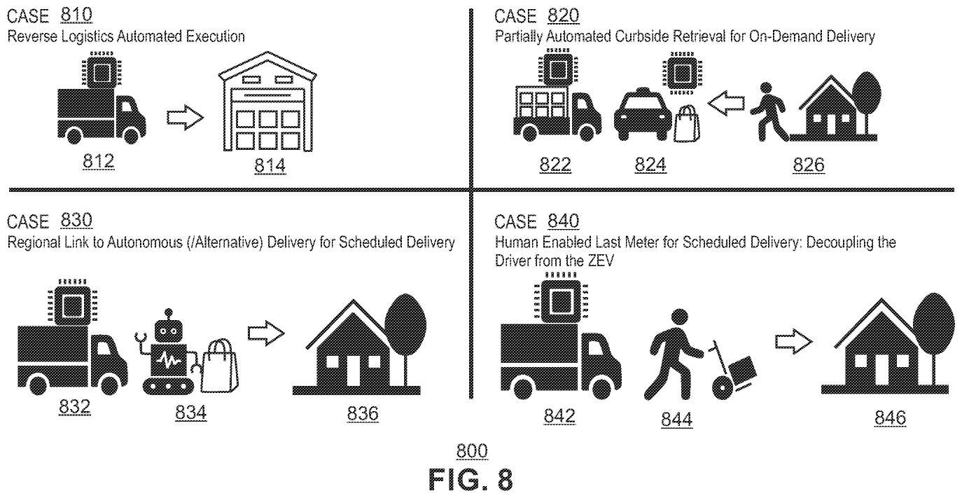

For the building types 610, the infrastructure of each respective building type is identified as being within or compliant with the specific domain or domains in which automated systems are designed to properly operate. Automated systems include, but are not limited to, autonomous vehicles and personal delivery devices. The personal delivery devices include drones, robots, and any automatically operated machine that replaces human effort. The domains are referred to as an operational design domain (ODD). In examples, the ODD specifies environmental conditions, minimum and maximum speed limits, drivable and non-drivable areas, robot accessible and non-accessible areas, time of day, and any combinations thereof, in which the automated system is designed to operate. For example, an autonomous vehicle (e.g., AV 102 of FIG. 1, AV 502 of FIGS. 5A-5C), has an associated ODD that governs conditions under which the autonomous vehicle is able to properly operate. Similarly, a robot (e.g., robot 834 of FIG. 8) has an associated ODD that governs conditions under which the robot is able to properly operate. As illustrated in the example of FIG. 6, houses 612 are designated as belonging to one or more ODDs 622A and as excluded from one or more ODDs 622B. Multistory buildings 612 are designated as belonging to one or more ODDs 624A and as excluded from one or more ODDs 624B. Delivery infrastructure locations 616 are designated as belonging to one or more ODDs 626A and as excluded from one or more ODDs 626B.

In some embodiments, the areas categorize locations of the map according to an accessibility type. For example of FIG. 6, areas 640, 650, and 660 are classified according to an accessibility type 630. The accessibility type refers to the type of access locations of a respective area provide for personal delivery devices. For example, the area 640 is a robot deliverable area, and the area 650 is a robot non-deliverable area. Area 642 includes houses 612 that cannot accept autonomous vehicle delivery. Area 652 includes multistory buildings 614 that cannot accept autonomous vehicle delivery.

In examples, a location is classified as belonging to the robot deliverable area 640 when robots are able to access the location and the location is accessible using autonomous vehicles. A location is classified as belonging to the robot cannot deliver area 650 when robots cannot access the location, however the location is accessible using autonomous vehicles. A location is classified as a delivery infrastructure location (and belonging to area 660) when the location includes a known support for receiving, sorting and/or forwarding packages to other locations. In some embodiments, the delivery infrastructure is a fulfillment center, delivery station, hub, and the like. Area 662 includes delivery infrastructures 616 that cannot accept delivery via autonomous vehicles.

The accessibility types 630 include accessibility subcategories. For example, each of the robot deliverable area 640 and the robot cannot deliver area 650 are associated with subcategories that segment locations within the areas according to infrastructure associated with each location. For example, each location is associated with having open access 632 or closed access 634. Open access 632 refers to the delivery location being accessible, without restrictions. Closed access 634 refers to the delivery location being gated or otherwise implementing controlled access. In examples, the open access 632 subcategory and closed access 634 subcategory governs autonomous vehicle access to a location. For example, if a location is associated with a closed access 634 subcategory due to gates located along a roadway, an autonomous vehicle may be unable to access the location without human assistance to resolve the closed access.

Additional accessibility type 630 subcategories segment locations within the areas according to infrastructure at the delivery location. In the example of FIG. 6, the doorstep at the delivery location is associated as being a flat doorstep 636, a standard doorstep 637, or a non-standard doorstep 638. In examples, a standard doorstep 637 includes steps or other features that are navigable by a robot. A nonstandard doorstep 638 includes steps or other features that are not navigable by a robot.

In examples, fleet management matches vehicles (e.g., human driven vehicles, autonomous vehicles, and personal delivery devices) to routes based on the area associated with locations along the routes. Vehicles are assigned to routes based on, at least in part, if the vehicle can properly operate in the area associated with the locations. The assignment of routes to vehicles is based on one or more factors or attributes. For example, the predefined map 600 includes information associated with locations of a robot-deliverable area 640 (Area 1), robot-cannot-deliver area 650 (Area 2), and area of delivery infrastructure 660 (e.g., delivery station, store, lockers, etc.) (Area 3). Information, such as if a building type 630 has gates/fences or other attributes can preclude delivery using a personal delivery device. In some embodiments, a personal delivery device is stowed within the autonomous vehicle. The personal delivery device is deployed to complete deliveries from the autonomous vehicle to a delivery location. However, if the location has gates, fences, or other attributes delivery by a personal delivery device may be precluded due to the closed access.

In some embodiments, fleet management includes assigning routes associated with delivery requests to vehicles that execute with ride requests. In examples, vehicles associated with ride requests are designated as being in one or more states. A vehicle state refers to a current service being provided by the vehicle, such as ride-hailing (e.g., executing ride requests) or on-demand delivery (executing delivery requests). In some embodiments, the state is used to determine the availability of the vehicle to complete delivery requests (e.g., on-demand deliveries, trunk deliveries) or ride requests, alone or in combination. In some examples, the fleet is a mixed fleet with both delivery vehicles, ride-hailing vehicles, and the like.

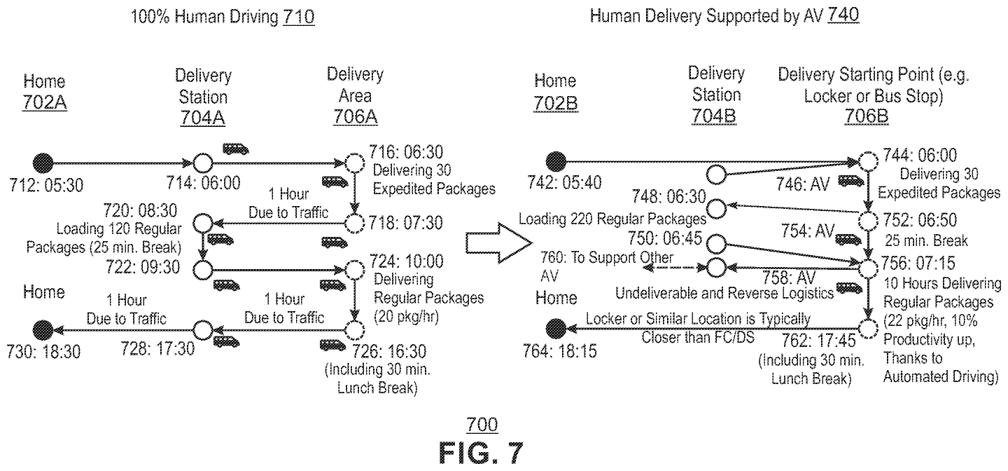

FIG. 7 is an example of decoupled operations between human driving and human delivery of packages. Execution of delivery requests by a human delivery driver/worker is illustrated using a human driving route 710 at several timestamps. The route 710 is completed by the human operating the vehicle, without automated systems (e.g., autonomous vehicle, personal delivery device). Execution of delivery requests is illustrated using an autonomous vehicle driven route 740 with a human delivery worker at several timestamps. The route 740 is completed using an autonomous vehicle (e.g., autonomous vehicle 102 of FIG. 1) and a human delivery worker.

In the example of FIG. 7, a human driven route 710 is illustrated from the perspective of a human delivery driver/worker that navigates the route (e.g., driving task) and delivers packages (e.g., worker task). Locations along the route 710 are home 702A of the human delivery driver/worker, a delivery station 704A, and a delivery area 706A. The route begins at 0530 hrs, timestamp 712. The human delivery driver/worker arrives at the delivery station 704A at 0600 hrs., timestamp 714. After loading the delivery vehicle with packages at the delivery station, the human delivery driver/worker proceeds to a delivery area at 0630 hrs., timestamp 716. The human delivery driver/worker spends approximately one hour delivering 30 expedited packages, and completes the delivery of the expedited packages at 0730 hrs., timestamp 718. The human delivery driver spends approximately one hour in traffic returning to the delivery station 704 to reload and continue with deliveries. Accordingly, at 0830 hrs., timestamp 720, the human delivery driver/worker loads the vehicle with 120 regular packages and takes a 25 minute break. At 0930 hrs., timestamp 722, the delivery driver leaves the delivery station 704A and travels to a delivery area 706A. At 1000 hrs., timestamp 724, the human delivery driver/worker delivers regular packages at a rate of approximately 20 packages per hour. The human delivery driver/worker also takes a 30 minute lunch break while in the delivery area 706A. At 1630 hrs., timestamp 726, the human delivery driver/worker returns to the delivery station 704A. The human delivery driver/worker spends approximately one hour in traffic returning to the delivery station 704A at 1730 hrs., timestamp 728. The human delivery driver/worker then leaves the delivery station 704A and returns to home 702A at 1830 hrs., timestamp 730. In the example of the route 710, the paid travel time for the human delivery driver/worker is 3 hours, including hours spent in traffic returning to the delivery station as well as time spent traveling between locations associated with package delivery. The personal travel time for the human delivery driver/worker is approximately 1.5 hours, and includes travel between home 702A of the human delivery driver/worker and the delivery station 704A. In the example of FIG. 7, the number of packages delivered is 120 regular packages and 30 expedited packages.

While navigating the route 710, deliveries using the human delivery driver/worker include two loading opportunities at a delivery station. The route 710 is a linear route, due to the human meeting with the delivery vehicle and traveling with the same delivery vehicle through the entire route, including trips back and forth to the delivery station 704A. The human delivery driver/worker travels some distance to meet the delivery vehicle, at the delivery station, get in the vehicle and drive to the delivery area.

In the example of FIG. 7, an autonomous vehicle driven route 740 is described from the perspective of a human that works along the route to delivery packages (e.g., worker task) and at least one autonomous vehicle that completes the driving task. The human is a delivery worker, and is decoupled from the driving task. Similar to the human driven route 710, locations along the route 740 are described as being at a home 702B of the human delivery worker, a delivery station 704B, and a delivery starting location 706B. The route 740 begins at 0540 hrs, timestamp 742. The human delivery worker proceeds to the delivery starting location 706B, and arrives at timestamp 744 at 0600 hrs. At some timestamp 746, an autonomous vehicle loaded with 30 expedited packages navigates from the delivery station 704B to the delivery starting place 706B. A first autonomous vehicle loaded with 30 expedited packages meets the human delivery worker at the delivery starting location 706B at 0600 hrs., timestamp 744. The expedited packages are delivered from the autonomous vehicle to the delivery location by the human delivery worker, and the human delivery worker completes delivery of the 30 expedited packages. Upon completion of the delivery of 30 expedited packages, at 0650 hrs., timestamp 752 the human delivery worker takes a 25 minute break. As the human delivery worker completes the delivery of the 30 expedited packages and/or takes a 25 minute break, the first autonomous vehicle 746 independently returns to the delivery station 704B, without the human delivery worker, who completes the delivery of the 30 expedited packages in completes a respective work break. As the first autonomous vehicle 746 independently returns to the delivery station 704B, a second autonomous vehicle 754 is loaded with 220 regular packages for delivery at 0630 hrs., timestamp 748. At 0645 hrs., timestamp 750, the second autonomous vehicle 754 loaded with 220 regular packages meets the human delivery worker at a delivery starting location 706B at 0715 hrs., timestamp 756. For ease of explanation, the first autonomous vehicle 746 and the second autonomous vehicle 754 as navigating between the delivery station 704B and the delivery starting location 706B in a series. However, the autonomous vehicles are operable in several modes of operation. In some embodiments, the mode of operation of the autonomous vehicle impacts a corresponding workflow of the human delivery worker.

Several workflows are executed in parallel, including: 1) the workflows of the autonomous vehicles; 2) the workflows of the human delivery worker supported by one or more autonomous vehicles; and/or 3) human only deliveries. Additionally, the autonomous vehicles are operable in multiple modes. A first mode is a driverless shuttle mode. In the driverless shuttle mode, a single autonomous vehicle delivers boxes to a worker in a deliver area. The worker then delivers those boxes while the single autonomous vehicle returns to a delivery station for additional packages. The single autonomous vehicle navigates between a delivery station and the human delivery worker, conveying packages back and forth. A second mode is a train mode. In the train mode, the autonomous vehicle picks up the delivery worker from a first location. The delivery worker rides a route along with the autonomous vehicle. At each delivery location, the delivery worker exits to deliver packages, and re-enters the autonomous vehicle. The delivery worker rides to the next delivery locations and exits the autonomous vehicle to deliver respective packages to each delivery location until the end of the shift. Autonomous vehicles loaded with packages are automatically available to replace empty vehicles during the worker's shift.

The driverless shuttle mode of operation and the train mode of operation correspond to different workflows for a human delivery worker. The driverless shuttle mode corresponds to a highly decoupled delivery worker workflow when compared with the train mode. For example, the autonomous vehicle returns to a delivery station while the worker is delivering packages in the shuttle mode, and the delivery worker workflow is independent from the autonomous vehicle as the vehicle navigates between a delivery station and the human delivery worker, conveying packages back and forth. The train mode of operation is slightly more coupled to the delivery worker workflow when compared with the driverless shuttle mode. In train mode, the delivery worker rides routes that are governed by the workflows of a series of autonomous vehicles. For example, the delivery worker rides a route of the first autonomous vehicle, exits the first of a train of autonomous vehicles to deliver packages until the last package from the first autonomous vehicle is reached. The delivery worker completes delivery of the last package and returns to a second autonomous vehicle of the train of autonomous vehicles, loaded with packages for delivery. The worker boards the new, reloaded, second autonomous vehicle and continues working to deliver packages.

After timestamp 756, the human delivery worker spends 10 hours delivering regular packages. In the example of FIG. 7, the human delivery worker delivers packages at a higher rate due to offloading of the driving task to the autonomous vehicles. For example, the human delivery worker delivers packages at 22 packages per hour with a 10% increase in productivity due to offloading of the driving task. In some embodiments, a third autonomous vehicle 758 receives undeliverable packages from the human delivery worker during the delivery by the human worker. The third autonomous vehicle 758 periodically returns to the delivery station 704B to return undeliverable packages and execute reverse logistics tasks as they arise. In examples, the return packages 760 are transported for support at another autonomous vehicle for delivery. At 1745 hrs., timestamp 762, the human delivery worker has completed work for the day, including a 30 minute lunch break. The human delivery worker returns from the delivery starting location 706B to home 702B at 1815 hrs., timestamp 764. In some embodiments, the delivery starting location 706B is located closer to the home 702B of the delivery worker when compared to the location of the delivery station 704B (e.g., fulfillment center, delivery station).

In some embodiments, the return packages 760 for the another autonomous vehicle are added to other routes. A human delivery worker delivers packages from an autonomous vehicle 758 in train mode. Additional packages are assigned to the autonomous vehicle 758 as the delivery worker delivers packages. Another autonomous vehicle conveys the additional packages to the location of the autonomous vehicle 758 and human delivery worker. The human delivery worker retrieves the additional packages from the another autonomous vehicle in shuttle mode, and adds the packages to the autonomous vehicle 758, operating in train mode with the delivery worker riding the route to deliver packages. This results in a faster, more efficient delivery of the additional packages.

While completing package delivery tasks, the human delivery worker is not routed to the delivery station to begin work, and does not return to the delivery station during the day, resulting in less paid time in traffic. In examples, the paid travel time to the human delivery worker is less than half an hour, and personal travel time of the human delivery worker is reduced to less than an hour. In the example of FIG. 7, a larger number of packages are delivered since the human delivery worker is not assigned driving tasks, such as parking and navigating roadways. Instead, the human delivery worker can prepare for deliveries while the autonomous vehicle completes the driving tasks, resulting in an increase in productivity. For example, the number of packages delivered is 220 regular plus 30 expedited with dedicated van loading. While navigating the route, deliveries using the human delivery supported by the AV include 2-4 loading opportunities at a delivery station.

As illustrated by the route 740, delivery vehicles are autonomous vehicles (e.g., autonomous vehicles 746, 754, and 758) that are not reliant on a human to navigate a route. In some embodiments, the human delivery worker and the autonomous vehicle meet at any location, and the location is not limited to the delivery station where the autonomous vehicle is loaded with packages. In some examples, the autonomous vehicle retrieves the human delivery worker from his or her home. In some examples, the human delivery worker and the autonomous vehicle meet near the first delivery area on the assigned route. When the human delivery worker and the autonomous vehicle meet, worker assisted deliveries begin. Deliveries continue throughout the worker's shift, and the worker is met by one or more vehicles (e.g., autonomous vehicles 746, 754, and 758) loaded with packages throughout the duration of the worker's shift. In examples, the worker's ending location is incorporated into the assigned route, so that the worker can end the shift at home or another requested ending location.

In this manner, the human delivery worker is able to work more efficiently due to a reduction in tasks and support provided by the autonomous vehicle. For example, the human delivery worker is able to complete deliveries more quickly because the delivery worker is not concerned about driving. Deliveries can occur without the need for vehicle stopping locations, parking, or other vehicle storage locations, as the vehicle can continue with the flow of traffic (e.g., circle the block or assist a second delivery worker nearby while deliveries by a first deliver worker are occurring). This eliminates a search for suitable parking, where suitable parking refers to parking that is large enough, enables vehicle access, is secure, and is legal. In some embodiments, suitable parking is in an inconvenient location with respect to the delivery location, and often requires extra time to traverse by foot. In some embodiments, the present techniques reduce the physical workload of the human delivery worker by enabling the human delivery worker to exit the vehicle with packages for delivery as close as possible to the delivery location. Moreover, the autonomous vehicle and human delivery worker are able to deliver more packages in a day as more time in the day is spent on the task of package delivery. In examples, none of the human worker's time is spent in transit to and from a delivery station or warehouse.

In some embodiments, the present techniques enable a transition of a human delivery driver/worker to a human delivery worker. Traditionally, routes are created and assigned under the idea that the package is driven to a location by a human and the human unloads the package at the client's location. The present techniques enable the delivery driver to become a delivery worker who is in service of the autonomous vehicle. In some embodiments, the delivery worker is responsible for particular delivery areas, and the autonomous vehicles can come and go to the delivery area independently. The autonomous vehicles operate using a workflow and dispatch that is separate from the delivery worker workflow and dispatch. The present techniques enable community servicing of delivery areas, where the delivery worker is responsible for (and identified with) delivery areas. In some embodiments, the delivery worker lives within the delivery area. In some embodiments, human delivery worker can visit several areas, all of which are linked based a predetermined starting location and an ending location for the delivery worker. The autonomous vehicles come and go between delivery areas and delivery stations, even in the middle of a delivery of packages to the delivery location by the human.

For example, an autonomous vehicle is loaded at first location and driven into a neighborhood. The autonomous vehicle picks up a human delivery worker (maybe from their own house), and the worker can immediately begin work by delivering packages from the pickup location. In examples, the worker delivers packages in his or her own neighborhood. The worker is dropped off at home at the end of their route. In some cases, another worker can be picked up to complete a remainder of the delivery route. In some embodiments, the autonomous vehicle drives to a delivery area and meets a personal delivery device (e.g., a field deployed robotic solution) to deliver packages. The personal delivery device retrieves packages from the autonomous vehicle and completes the delivery of the packages to the delivery location. In some embodiments, the personal delivery device is stored onboard the autonomous vehicle. Accordingly, the present techniques decouple or disassociate attributes of the vehicle, personal delivery devices, human workers, and packages. In embodiments, various permutations of the vehicle, delivery devices, human workers, and packages are derived based on the attributes and timing information associated with the vehicle, delivery devices, human workers, or packages.

As illustrated by the example of FIG. 7, the loading/unloading of packages and routes are optimized through the use of automated systems. In examples, an optimization is locating a delivery station located farther away from delivery area to reduce real estate costs associated with the delivery station. Routes can originate from farther-away delivery stations, located at affordable locations outside of dense urban centers. While a large number of delivery locations are within urban areas, the use of autonomous vehicles to access these areas from delivery stations outside of the urban areas reduces costs associated with package delivery. Further cost reductions in package delivery includes savings realized from lower commute costs, since a human driver is not required to commute to and from the delivery stations. In some embodiments, varying levels of automation are used to support or replace human drivers and human workers.

In some embodiments, the present techniques determine how to dispatch vehicles with these varying levels of automation in response to the attributes of each location as stored in the predefined map 600 as described in reference to FIG. 6. The present techniques enable denser and more optimized routes that have different starting locations and ending locations. In examples, the routes start and end at locations selected for the most dense, efficient use of the delivery agent (e.g., human worker, personal delivery device).

For ease of description, a fully autonomous vehicle is referred to as an autonomous driving vehicle without a driver's seat. The fully autonomous vehicle completes driving tasks without a human controlling (e.g., in the driver seat or remotely controlling) motion of the vehicle. In examples, a fully autonomous vehicle includes a driver's seat, and a human can optionally control the fully autonomous vehicle (e.g., either seated within the vehicle or remotely). As described with respect to FIG. 8, autonomous vehicles with varying levels of autonomous functionality are used to deliver packages to areas of a predefined map (e.g., predefined map 600 of FIG. 6). In some embodiments, fleet management in the one or more areas can be classified into one or more cases according to the automated systems used and assigned routes.

FIG. 8 is an illustration of exemplary cases 800. In some embodiments, the cases are implemented and managed using delivery fleet management. In some embodiments, a predefined map (e.g., predefined map 600) associates a location with at least one of a delivery type, a building type, and accessibility type, or any combinations thereof. As discussed above, the building type and accessibility type are used to define areas. In embodiments, the areas are further refined by the client's delivery method type.

Case 810 illustrates reverse logistics automated execution (RELAX). In some embodiments, case 810 includes the use of an autonomous vehicle 812 that navigates to a delivery infrastructure location 814, where the delivery infrastructure is a fulfillment center or delivery station that receives packages for delivery to locations within a predetermined region (e.g., one or more areas). In examples, the autonomous vehicle 812 navigates to the infrastructure location 814 and is unloaded to enable automated execution of reverse logistics tasks. Reverse logistics refers to operations that routes packages in-bound to a delivery station. For example, an autonomous vehicle 812, such as a fully-automated zero emissions vehicle (ZEV) cargo van, performs automated relay-legs from drop off locations to outbound sort facilities (e.g., delivery infrastructure location 814). In some embodiments, case 810 includes forward logistics automated execution. In forward logistics automated execution, the autonomous vehicle delivers packages from outbound sort facilities to staffed endpoints such as lockers. Additionally, in a forward logistics automated execution, the autonomous vehicle delivers packages for lateral logistics, or between delivery stations. As illustrated in the example of FIG. 8, case 810 results in a savings of approximately 80% driver costs, as load/unload labor is still used at the autonomous vehicle. Additionally, the use of the autonomous vehicle to complete routes from drop-off locations to outbound sort facilities results in more frequent hauls, without the need for rests or breaks needed by human drivers.

In some embodiments, the present techniques are used with reverse logistics. Traditionally, when a human driver is assigned a route, any undeliverable packages may not go back to the delivery station until the deliveries are completed and the vehicle returns to the station at the end of the route. The present techniques enable opportunities to send the vehicle back to the delivery station or warehouse with undeliverable orders and returns that were picked up. Accordingly, the present techniques decouple the human workflow from the movement of goods back and forth between their source/destination and their delivery geography (the delivery geography that is relevant at that moment in time).

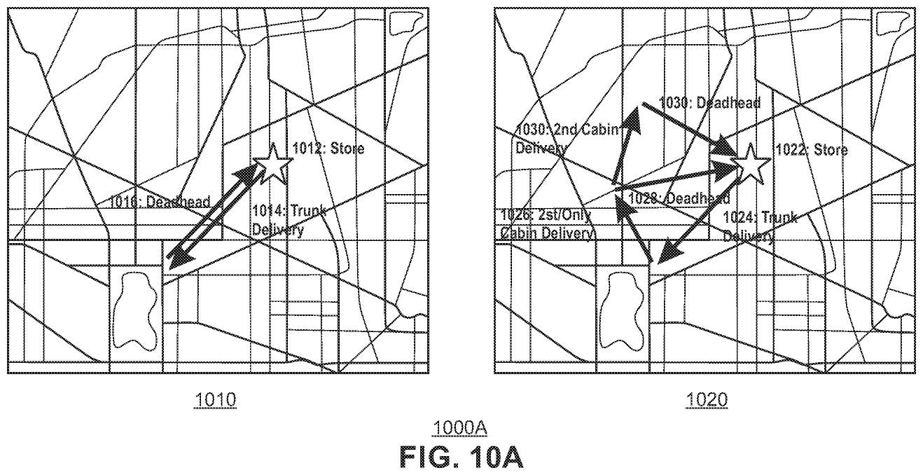

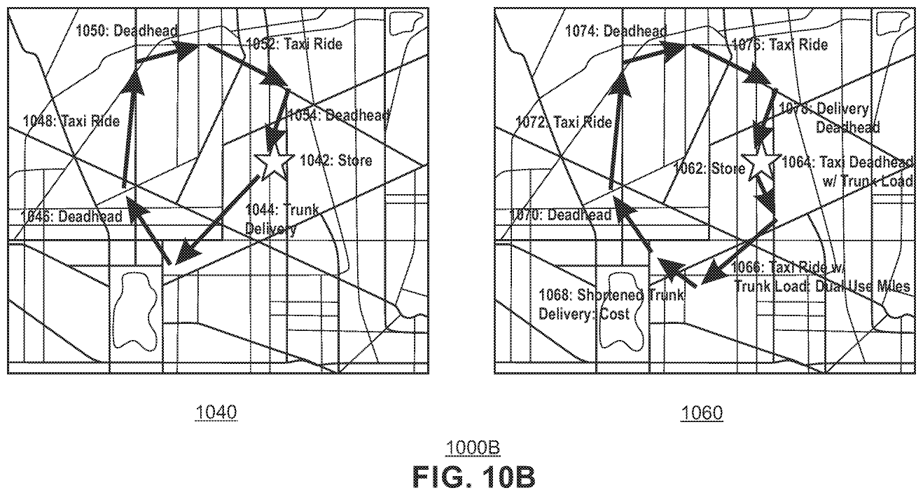

Case 820 illustrates a partially automated curbside retrieval (PACT) for on-demand delivery. In an example, case 820 includes partially automated curbside retrieval. Here, the client meets the autonomous vehicle to retrieve packages from the vehicle. In examples, the client meets the autonomous vehicle at a predefined time to retrieve a package. In embodiments, an autonomous vehicle (e.g., a fully-automated ZEV) is loaded at a store, delivery station, or other delivery infrastructure. In some embodiments, the autonomous vehicle is a fully autonomous vehicle such as fully-automated ZEV 822 that is a dedicated PACT vehicle with lockers or other dividers to segment packages for delivery based the delivery location. In some embodiments, autonomous vehicle 822 is outfit with a human machine interface, and the client uses the human machine interface to retrieve the delivery. In some embodiments, the autonomous vehicle is a ride hailing vehicle 824 that enables trunk delivery as described below in reference to FIGS. 10A-10B.

In examples, the client is notified when the autonomous vehicle 822/824 arrives at the curbside, and the client retrieves the package from the autonomous vehicle 822/824. For example, the client accesses a locker or controlled segmented access point of the autonomous vehicle 822 to retrieve packages. In another example, the client accesses a trunk, frunk, or other cargo area of an autonomous vehicle 824 to retrieve packages. As illustrated in the example of FIG. 8, case 820 results in approximately one—three deliveries per route when package delivery is completed using a ride hailing vehicle (e.g., robo-taxi fleet). Case 820 results in five or more deliveries per route using a dedicated PACT vehicle. As illustrated in the example of FIG. 8, case 820 results in a fully automated on-demand last mile, minus some client incentive.

In some examples, in case 820 includes the autonomous vehicle 822/824 includes a robotic load/unload device for deliveries. For example, the autonomous vehicle 822/824 is loaded using a robotic device, and navigates to delivery locations where packages are unloaded from the autonomous vehicle by a robotic arm. In this example, both of the loading and unloading is done using a base vehicle and infrastructure on each of the dispatch (e.g., loading) side and client (e.g., unloading) side for package management.

Case 830 illustrates a Regional Link to Autonomous (/Alternative) delivery for scheduled delivery (RELAY). In some embodiments, case 830 includes the use of an autonomous vehicle 832 that includes a robot 834. In some embodiments, the robot 834 is a final step delivery device or a personal delivery device. In examples, when a delivery is made to a residential address and there is no delivery infrastructure available, robotics on board the vehicle are used to move the packages to a doorstep of the delivery location. In examples, a robot 834 completes delivery, or an automated conveyor receive deliveries at the delivery location. In some cases, a human located at the delivery location is used to complete the offloading. For example, in case 830 a delivery agent retrieves packages, such as a doorman located at the delivery location.

The autonomous vehicle 832 navigates to delivery locations, and the robot 834 is stowed on the autonomous vehicle 832. At each respective delivery location, the robot 834 removes a package from the autonomous vehicle 832 and completes the delivery of the package to a doorstep of the client. The robot 834 returns to the autonomous vehicle 832 that navigates to a next delivery location. In the example of case 830, an autonomous vehicle (e.g., a fully-automated ZEV cargo van) is loaded inside a delivery center and includes a delivery robot. The fully loaded vehicle drives autonomously to the delivery area, and a robot (or alternative agent) executes deliveries. In case 830, the scheduled deliveries are five are more deliveries per route. The routes are fully automated throughout the last mile to client doorstep.

Case 840 illustrates a human enabled last meter (HELM) for scheduled package delivery. Case 840 decouples the human worker from the driving completed by the autonomous vehicle. In embodiments, an autonomous vehicle 842 (e.g., fully loaded fully-autonomous ZEV cargo van) navigates to a location to pick up a human delivery worker 844 at or near the start of a route. During navigation of the route, the autonomous vehicle 842 directs the worker in delivering packages from the autonomous vehicle 842 to the client doorstep. In examples, as the route nears completion and packages from a first autonomous vehicle are delivered, another autonomous vehicle loaded with additional packages arrives. When the final package is delivered from the first autonomous vehicle, the first autonomous vehicle departs, and the human worker boards the second autonomous vehicle. As each autonomous vehicle is emptied of packages for delivery, a next autonomous vehicle loaded with additional packages arrives. The emptied autonomous vehicles return to the delivery station for refill. At shift end, the last autonomous vehicle drops off the delivery worker at a predetermined location. In examples, case 840 enables 30-45% increase in productivity gains when compared to human driver/worker based deliveries. Additionally, case 840 enables routing schemes that leverage the independent navigation of the autonomous vehicle between delivery locations and delivery infrastructure. The present techniques enable lower-cost delivery centers, higher frequency trips, and more/better worker access.

In some embodiments, a human delivery worker shift is decoupled from a capacity of the autonomous vehicle (e.g., the number of packages able to be loaded onto a vehicle does not impact a human delivery worker shift). Traditionally, enough packages are loaded onto a vehicle so that a human delivery worker can complete, for example, a four hour delivery shift. A traditional goal in generating routes for package delivery is to prevent the human delivery worker from being without packages for delivery prior to the end of the shift. If the human delivery worker runs out of packages for delivery prior to the end of their shift, then time is wasted by driving back to the delivery station to pick up additional packages. In the traditional case, the delivery driver/worker spends time sitting in traffic, deadheading, and the like. With the present techniques, the worker can be picked up (e.g., retrieved by the AV) from their front door or other predetermined location. In examples, if the worker is two hours into a shift and runs out of packages for delivery, the worker exits a current vehicle with the package for delivery to an address, a new vehicle arrives with additional packages, and the empty vehicle leaves. The worker boards the new vehicle and continues the delivery route as if nothing happened. In this manner, a seamless coordination between the human performing the delivery work (or a robot performing the delivery work) and the shuffling of packages back and forth from their source is enabled. In embodiments, a vehicle running out of packages for delivery does not cause a change in the delivery agent workflow, as a fresh vehicle with packages is provided immediately, in real-time.

In some embodiments, each of the cases 810, 820, 830, and 840 are realized using an autonomous vehicle as the base platform. In a first variant (e.g., case 820), a client retrieves the package directly from the autonomous vehicle. In examples, the autonomous vehicle includes a human machine interface that enables clients to retrieve packages from the autonomous vehicle. In the second variant, the autonomous vehicle navigates to delivery locations and robotics are used to support robot (e.g., robot 834) delivering of packages to a doorstep. In the third variant (e.g., case 840), the autonomous vehicle navigates to delivery locations and supports a human delivery to a doorstep.

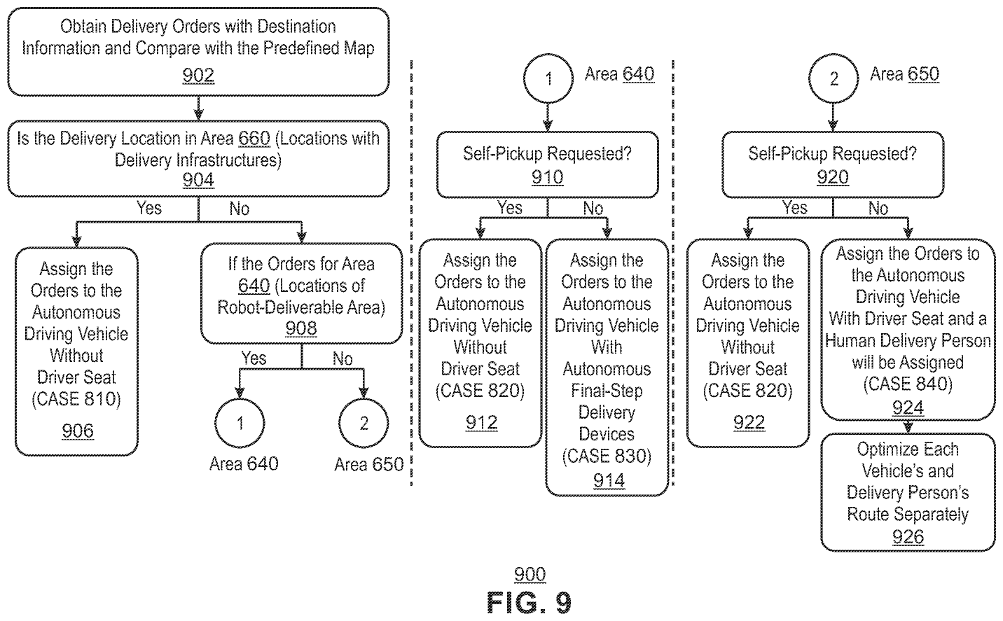

FIG. 9 is an exemplary process for fleet management. In some embodiments, the process 900 is implemented (e.g., completely, partially, etc.) using an AV system that is the same as or similar to AV system 114, described in reference to FIG. 1. In some embodiments, the process 900 is implemented (e.g., completely, partially, etc.) using a fleet management system 116, described in reference to FIG. 1. In some embodiments, the process 900 is implemented (e.g., completely, partially, and/or the like) by a device that is the same as or similar to the device 300 of FIG. 3. In some embodiments, the process 900 includes any of the above-noted systems in cooperation with one another. In some embodiments, the device 900 is a personal device (e.g., smart phone, tablet, laptop, etc.).

At block 902, package deliveries and the associated delivery information are compared with a predefined map (e.g., map 600). In some embodiments, the delivery location is assigned to an area of a predetermined map based on an accessibility type and an accessibility sub-category. An extent of autonomous functionality of a vehicle for delivery of the package to the area is determined, wherein the extent of autonomous functionality describes an autonomous capability of the vehicle. In examples, the extent of autonomous functionality of the vehicle for delivery of the package includes the presence or lack of a delivery agent (e.g., robot 834 of FIG. 8, human worker 844 of FIG. 8).

Accordingly, at block 904, it is determined if the delivery location belongs to an area with a delivery infrastructure based on the map. For example, locations associated with areas 660/662 of the predefined map described with reference to FIG. 6 include a delivery infrastructure. As used herein, a delivery infrastructure includes delivery centers, staff endpoints, lockers, lateral logistics, and the like. In examples, a delivery infrastructure present at the delivery location enables the packages to be offloaded. In some embodiments, the delivery infrastructure enables the packages to be offloaded in roughly the same way they were loaded.

At block 906, if the delivery location is in area 660, the orders are assigned to an autonomous driving vehicle without the driver's seat (e.g., case 810 of FIG. 8). For example, if the location has a delivery infrastructure, at block 906 the delivery can be completed without a human, a robot, or other delivery device. In some embodiments, the delivery is assigned to an autonomous vehicle without a delivery device.

At block 908, it is determined if the orders are for area 640 of the predetermined map 600 described with respect to FIG. 6. Area 640/642 includes locations in robot deliverable areas. If the delivery location is within area 640, process flow continues to block 910. If the delivery location is not within area 640, process flow continues to block 920.

At block 910, the area is a robot deliverable area 640 and it is determined if client has requested a self-pickup (e.g., curbside delivery). For example, at block 910 it is determined if the client is able or willing to retrieve the packages from the autonomous vehicle. If the client can retrieve the package from the autonomous vehicle, process flow continues to block 912. If the client cannot retrieve the package from the autonomous vehicle, process flow continues to block 914. At block 912, the delivery location is assigned to an autonomous driving vehicle without a driver's seat (e.g., case 820 of FIG. 8). During delivery, the client approaches the vehicle and obtains the package from the autonomous vehicle. At block 914, the delivery is assigned to an autonomous driving vehicle with autonomous final-step delivery devices (e.g. case 830 of FIG. 8). Accordingly, in some embodiments the autonomous functionality of the vehicle includes a personal delivery device that is stored on the vehicle and enables final step delivery. In some embodiments, at block 912 or block 914, the package is delivered via ride hailing fleet management as described below in FIGS. 10-17.

At block 920, the area is a robot cannot deliver area and it is determined if client has requested a self-pickup (e.g., curbside delivery). For example, at block 920 it is determined if the client is able or willing to retrieve the packages from the autonomous vehicle. If the client can retrieve the package from the autonomous vehicle, process flow continues to block 922. If the client cannot retrieve the package from the autonomous vehicle, process flow continues to block 924. At block 922, the delivery location is assigned to an autonomous driving vehicle without a driver's seat (e.g., case 820 of FIG. 8). During delivery, the client approaches the vehicle and obtains the package from the autonomous vehicle. At block 924, the delivery location is assigned to an autonomous driving vehicle with a driver's seat and a human delivery worker (e.g., case 840 of FIG. 8). At block 926, the route assigned to the autonomous vehicle and the workflow of the delivery worker route are separately optimized as described with respect to FIGS. 7 and 8. In some embodiments, at block 922 or block 924, the package is delivered via ride hailing fleet management as described below in FIGS. 10-17.

Accordingly, the present techniques enable fleet management by generating routes to deliver packages using the autonomous functionality of the vehicle within each respective area and transmitting routes to the vehicles, wherein the vehicles are configured to navigate the routes to deliver the packages to the delivery locations. The present techniques enable fleet operators to design optimized routes of autonomous driving vehicle fleets incorporating each location's ability to be serviced by automated systems and using a common base vehicle platform. In some embodiments, the automated systems and common base vehicle platform enable an incremental path to automation by expanding automated service of a fleet over time. Additionally, by decoupling a workflow of a human delivery worker from a route assigned to the autonomous vehicle route, less time and money consumed by traveling human workers. Further, the present techniques enable around the clock scheduling of automated deliveries.

The present techniques enable delivery fleet management including ride hailing fleet vehicles. In some embodiments, a ride-hailing fleet is simultaneously purposed as a cargo-area (e.g., trunk) delivery fleet. Routes associated with ride requests and small size on-demand delivery requests (e.g., grocery delivery, small documents delivery, meal delivery) are optimized. For example, an exemplary process includes an interface to identify request types such as ride requests (e.g., requests for ride-hailing services), delivery requests (e.g., on-demand delivery services) or combined ride requests and delivery requests.

FIGS. 10A and 10B are examples of delivery schemes for trunk delivery. For purposes of explanation, a minimal dispatch idle time and a conservative twenty minute transit time are selected. Additionally, a worst case average delivery distance is set at 7.2 miles, and trunk deliveries occur within an area defined by 12 mile delivery radius around a centroid located at a pickup location. In some examples, the delivery radius for urban locations is smaller than the 12 mile delivery radius. A ten minute median transit time for median average delivery distance is set at 2.5 miles. Additionally, a fifteen minute client delivery time (manned delivery averages 11 minutes) and a five minute pickup or loading time at the store is selected. Although particular time durations have been described, any time durations are used. The schemes are described in terms of efficiencies, and the delivery schemes can be integrated into the fleet management as described above.

The delivery scheme 1010 describes a single load dedicated delivery. In a single load dedicated delivery scheme 1010, package pickup for trunk delivery 1014 occurs at a store location 1012. Upon completion of the trunk delivery at a client specified delivery location, the vehicle deadheads 1014 back to the store location 1012 to initiate another delivery. In the example of FIG. 10, events associated with a single load dedicated delivery include for a conservative case transit estimate, events and their associated durations include pickup (e.g., five minutes), transit (e.g., 20 minutes), delivery (e.g., 15 minutes), and the deadhead transit (e.g., 20 minutes) for return to the store. A sum of the time associated with a single load dedicated delivery scheme 1010 is approximately 60 minutes for a conservative case transit estimate. This results in one delivery per hour. For a median case transit estimate, events and their associated durations include pickup (e.g., five minutes), transit (e.g., 10 minutes), delivery (e.g., 15 minutes), and the deadhead transit (e.g., 40 minutes) for return to the store.

The delivery scheme 1020 describes a multiple load dedicated delivery. In a multiple load dedicated delivery scheme 1020, package pickup for trunk delivery 1024 occurs at a school store location 1022. During pickup in a multiple load dedicated delivery scheme 1020, multiple deliveries are loaded in a single pickup event. A trunk delivery 1024 occurs, followed by a first cabin delivery 1026. In the case where two deliveries are loaded at the store, after the first cabin delivery 1026, the vehicle deadheads 1028 back to the store location 1022 to initiate another delivery. In the case where three deliveries are loaded at the store, after the first cabin delivery 1026, the vehicle proceeds to a second location for a second cabin delivery 1030. In some embodiments, deliveries continue until all loaded deliveries are made. After the final multiple load delivery, the vehicle deadheads 1030 back to the store location 1022.

In the multiple load dedicated delivery scheme 1020, there is a 50% additional pick up time associated with each of the additional second and third orders. Additionally, there is a savings of 50% of a transit leg duration, and a single deadhead duration is eliminated per additional pickup.

For two loads, an estimate of delivery transit in a multiple load dedicated delivery scheme 1020 is calculated as follows:

$$\frac{1.5 * Pickup + Transit + Delivery + 0.5 * Transit + Delivery + Transit}{2}$$

For example, using the time durations described above for purposes of explanation, a conservative case transit estimate for two loads is as follows:

$$\frac{7.5 + 20 + 15 + 10 + 15 + 20}{2} = 43.75 mins per delivery$$

The conservative case transit estimate results in approximately 1.4 deliveries per hour for two loads.

In examples, using the time durations described above for purposes of explanation, a median case transit estimate for two loads in the multiple load delivery scheme is as follows:

$$\frac{7.5 + 10 + 15 + 5 + 15 + 10}{2} = 31.25 mins per delivery$$

The median case transit estimate results in approximately 1.9 deliveries per hour for two loads.

In examples, using the time selected described above for purposes of explanation, a conservative case transit estimate for three loads in a multiple load dedicated delivery scheme 1020 is as follows:

$$\frac{10 + 10 + 15 + 5 + 15 + 5 + 15 + 10}{3} = 28.3 mins per delivery$$

The conservative case transit estimate results in approximately 2.1 deliveries per hour for three loads.

The delivery scheme 1040 is an interleaved delivery scheme with distinct missions. For example, the distinct missions include vehicle use as a taxi or vehicle use as a trunk delivery. In the interleaved delivery scheme 1040 with distinct missions, package pickup for trunk delivery 1044 occurs at a store location 1042. A trunk delivery 1044 occurs, and the vehicle deadheads 1046 until a ride request is received. The vehicle executes a client in response to the ride request and provides a taxi ride 1048. Upon completion of the taxi ride 1048, the vehicle deadheads 1050 until another ride request is received. The vehicle executes another route in response to the second ride request and provides a taxi ride 1052. Upon completion of the taxi ride 1052 the vehicle deadheads 1054 until the vehicle returns to the store location 1042.

For the interleaved robo taxi delivery scheme 1040, an estimate of delivery transit is calculated as follows:

Pickup+Transit+Delivery+0.5*Transit(Deadhead)

For example, using the time durations described above for purposes of explanation, a conservative case transit estimate for two loads in a interleaved delivery scheme 1040 with distinct missions is as follows:

5+20+15+10=50 mins per delivery

The conservative case transit estimate results in approximately 1.2 deliveries per hour.

Similarly, a median case transit estimate for two loads in a interleaved delivery scheme 1040 with distinct missions is as follows:

5+10+15+5=35 mins per delivery

The median case transit estimate results in approximately 1.7 deliveries per hour.

The delivery scheme 1060 is a trunk carpool. For example, in a trunk carpool a taxi ride in a trunk delivery are loaded onto a single vehicle. In the trunk carpool scheme 1060, package pickup or trunk delivery 1064 with a taxi deadhead occurs at the store location 1062. Prior to completion of the trunk delivery 1064, the vehicle executes a client for a taxi ride 1066 with the trunk load aboard the vehicle. In this manner, the vehicle is able to execute dual use miles. The taxi ride is completed and the trunk delivery resumes as a shortened trunk delivery 1068. Upon completion of the shortened trunk delivery 1068, the vehicle deadheads 1070 until a ride request is received. The vehicle executes a client in response to the ride request and provides a taxi ride 1072. Upon completion of the taxi ride 1072, the vehicle deadheads 1074 until another ride request is received. The vehicle executes a client in response to the ride request and provides a taxi ride 1076. Upon completion of the taxi ride 1076, the vehicle deadheads 1078 and returns to the store location to initiate another trunk delivery. In some embodiments, during a trunk carpool delivery 1060 the taxi cost is fully assigned to the taxi trip.

For the trunk carpool delivery 1060, an estimate of delivery transit is calculated as follows:

Pickup+0.5*Transit+Delivery+0.5*Transit

For example, using the time durations described above for purposes of explanation, a conservative case transit estimate in a trunk carpool scheme 1060 is as follows:

5+10+15+10=40 mins per delivery

The conservative case transit estimate results in approximately 1.5 deliveries per hour.

Similarly, a median case transit estimate in a trunk carpool scheme 1060 is as follows:

5+5+15+5=30 mins per delivery

The median case transit estimate results in approximately 2 deliveries per hour.

In some embodiments, the present techniques enable dual mode last mile delivery. Traditionally, final step delivery devices, such as sidewalk delivery robots, are limited to starting at a grocery store or other delivery source and driving to a delivery location. The delivery is made, and the sidewalk delivery robot is empty. No further functionality is possible after the delivery of the order. The sidewalk robot returns empty to the grocery store. Traditionally, time is wasted when the robot is not carrying a load for delivery, as the robot does not earn money when empty. The present techniques enable a dual mode during ride hailing with trunk delivery. For example, when a client is picked up in addition to or near a grocery delivery, additional revenue is possible. In embodiments, a grocery store is a continuous delivery source, and ride requests often end at the grocery store. In some embodiments, combining ride requests and delivery requests together into one managed platform creates a far higher efficiency. In particular, the present techniques enable more revenue generating minutes and miles versus deadhead nonrevenue generating miles.

Accordingly, in examples a grocery order (e.g., on-demand delivery request) is for trunk delivery and a ride hailing client (e.g., rider request) is retrieved at the same source. Both the ride hailing transportation and package delivery occur substantially simultaneously using the same physical resource (e.g., autonomous vehicle). In this manner, dual revenue miles are achieved and clients are not inconvenienced by the additional delivery requests.

The present techniques enable evaluation of the use of the trunks (e.g. cargo area) for logistics applications and delivery requests versus the use of the cabin of the vehicle for ride requests according to an algorithm. In some cases, the package in the cargo area responsive to a delivery request has priority over the client in the cabin responsive to a ride request (e.g., frozen items previously picked up should be delivered before the client). In examples, if the vehicle has a grocery order in the trunk picked up over a predetermined amount of time ago (e.g., a grocery order picked up 1.5 hours ago), the vehicle is precluded from picking up a client with a ride request that would cause the vehicle to exceed an amount of time allotted to complete the delivery request. For example, the groceries are required to be delivered within a two hour window. In this example, the autonomous vehicle cannot not accept a ride request that causes the autonomous vehicle to deliver the groceries picked up 1.5 hours ago outside of the predetermined two hour window. In the event that a ride request is in progress when the predetermined grocery pick up window is in danger of being exceeded, a detour may be added to the ride hailing trip in progress.

Effective management of the cargo area delivery space for delivery requests and ride requests enables better utilization of assets. The present techniques create a broader pool of demand and a broader pool of resources. The broader pool of demand and the broader pool of resources are serviced using the same physical assets. In some embodiments, matching between service requests (e.g., ride requests and delivery requests) and service providers (e.g., autonomous vehicles) is done more efficiently. The present techniques enable a fixed resource that serves multiple types of demand at the same time.

In some embodiments, the present techniques assign routes to vehicles in view of hybrid intersections. For example, the hybrid intersections include going to pick up a client responsive to a ride request, where the client is carrying packages and requires use of the trunk. Hybrid intersections also include vehicles currently occupied by a client and navigating to pick up a package responsive to a ride request, or vice versa. These permutations are managed using a state machine according to the present techniques. Priority between the delivery request and the ride request is balanced. For example, a decision may be made to interrupt the delivery of packages responsive to a delivery request by picking up a client responsive to a ride request, or a delivery picked up (or dropped off) and the client is inconvenienced by picking up the delivery for dropping off the delivery, and so on. This information is used to make decisions regarding whether or not the vehicle will accept a particular delivery request or ride request.

For example, if groceries need to be delivered within the next 10 minutes, that vehicle can no longer be used to service ride requests. In such a scenario, the delivery request takes priority over the ride request. In embodiments, the delivery request will take priority over a ride request in progress. Once delivery is complete, the vehicle can determine if a new ride request or new delivery request is able to be accepted. Accordingly, fleet management includes evaluations of multiple possible states of a fleet vehicle. Decision criteria is applied to the state of the vehicle. The decision criteria evaluates the state of the vehicle in view of an estimated time of arrival as well as cargo space available in the vehicle.

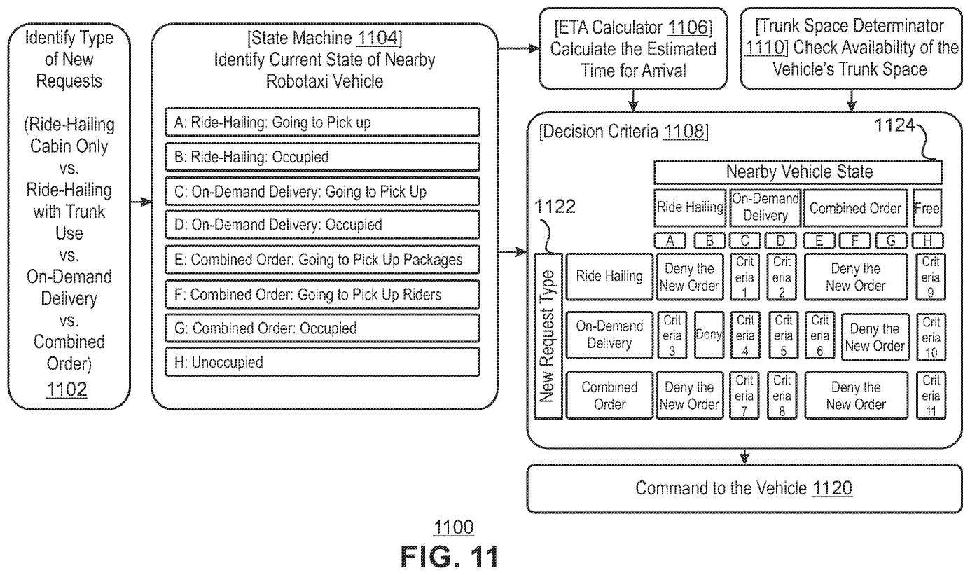

FIG. 11 is an exemplary process 1100 for fleet management of ride hailing capable vehicles. In some embodiments, the process 1100 is implemented (e.g., completely, partially, etc.) using an AV system that is the same as or similar to AV system 114, described in reference to FIG. 1. In some embodiments, the process 1100 is implemented (e.g., completely, partially, etc.) using a fleet management system 116, described in reference to FIG. 1. In some embodiments, the process 1100 is implemented (e.g., completely, partially, and/or the like) by a device that is the same as or similar to the device 300 of FIG. 3. In some embodiments, the process 1100 includes any of the above-noted systems in cooperation with one another. In some embodiments, the device 1100 is a personal device (e.g., smart phone, tablet, laptop, etc.). In some embodiments, the process 1100 is integrated into the process 900 of FIG. 9.

At block 1102, a request type is identified. In examples, the request includes a starting location, and ending location, and a delivery or transportation type. For example, a request type is a ride request with use of the cabin for client seating during transportation from the starting location to the ending location. In examples, a request type is a ride request with use of the cabin for client seating during transportation from the starting location to the ending location and use of the cargo space for packages. In examples, the request type is an on-demand delivery request, with use of the cargo areas for package delivery. In examples, the request type is a combined order, where each of a ride request and a delivery request are made. In some embodiments, an identification of the received request is provided as input to a state machine.

At state machine 1104, a state of at least one vehicle near the starting location of the received request is determined. In some embodiments, a vehicle is near a location identified in a request when the vehicle is within a predetermined radius with a location in the request as the centroid. In examples, the predetermined radius is iteratively increased to determine a nearby vehicle that is available to execute the request.

In examples, the state is identified using a state machine 1104. The state machine is configured to transition from a first active state to a second active state based on a status of the cargo space, cabin, and a currently assigned route. In some embodiments, the state machine enables a determination of if a new request is accepted (e.g., will be serviced by a current vehicle) based on a current state of the vehicle and the work that is currently being done by the vehicle. The present techniques enable the interleaving of ride hailing workloads with delivery workloads. In some embodiments, the state machine is used by a fleet delivery manager to determine the availability of the vehicle for execution of requests, as well as a precedence of the requests.

As illustrated in the example of FIG. 11, multiple states are identified for each nearby vehicle. In examples, State A is a ride hailing state with the vehicle navigating to pick up a client in response to a ride request. State B is a ride hailing state with the vehicle occupied by a client in response to a ride request. State C is an on-demand delivery state, with the vehicle navigating to pick up an on-demand delivery. State D is an on-demand delivery state, with the vehicle cargo space occupied by at least one on-demand delivery. State E is a combined delivery state, with the vehicle navigating to pick up packages for delivery. State F is a combined delivery state, with the vehicle navigating to pick up a client in response to a ride request. State G is a combined delivery state, with the vehicle occupied with both packages for delivery and a client in response to a ride request. States H is an unoccupied state, with both client availability and package delivery availability. In examples, a combined order refers to a trunk delivery request (e.g., potentially for on-demand delivery) and a ride request simultaneously executed simultaneously (e.g., ride-hailing request from A to B with order of a bottle of milk, bread and butter and vegetables stored in the cargo area).

The state as output by the state machine 1104 is input to an estimated time of arrival (ETA) calculator 1106 and a decision criteria evaluator 1108. In some embodiments, the ETA calculator 1106 estimates an arrival time associated with the received request (e.g., block 1102) if the request in executed by a nearby vehicle with the identified state. For example, the request is a ride request to transport a client from a starting location to and ending location. The ETA calculator 1106 determines an estimated time of arrival at the starting location, the ending location, or both for a respective nearby vehicle to execute the ride request. In examples, the request is a trunk delivery request, with use of the cargo areas for package delivery. The ETA calculator 1106 determines an estimated time of arrival at the package pickup location, the delivery location, or both for a respective nearby vehicle to execute the trunk delivery request. In examples, the request is an on-demand delivery, wherein a client requests goods that are packaged and delivered on-demand. The ETA calculator 1106 determines an estimated time of arrival at the package pickup location, the delivery location, or both for a respective nearby vehicle to execute the ride hailing trunk delivery request.

In examples, the request is a combined delivery request that includes both of a ride request and a trunk delivery request. The ETA calculator 1106 determines an estimated time of arrival at the starting location of the ride request, the ending location of the ride request, a package pickup location, the delivery location, or any combinations thereof for a respective nearby vehicle to execute the ride hailing trunk delivery request.

At the decision criteria evaluator 1108, the received request (e.g., block 1102), the nearby vehicle states (e.g., state machine 1104), and estimated times of arrival (e.g., ETA calculator 1106) associated with the received request in view of a respective nearby vehicle are input to evaluated to determine if the requests area accepted for execution by an autonomous vehicle. Additionally, the decision criteria evaluator 1108 obtains an availability of the cargo space of the respective autonomous vehicle from the trunk space determinator 1110.

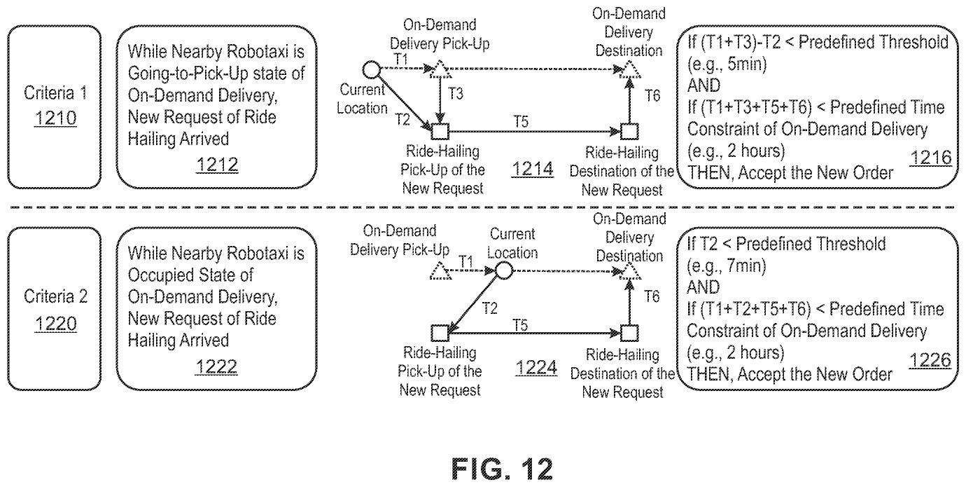

The decision criteria evaluator 1108 determines the availability of an autonomous vehicle for execution of requests, as well as a precedence of the requests. Decision criteria are dynamic, and the applicable decision criteria are based on, at least in part, the state of the nearby vehicle. The decision criteria guides an evaluation of estimated time periods (e.g., T1-T6 of FIGS. 12-17) associated with execution of requests. If the estimated time periods fail to satisfy a predefined threshold or predefined time constraints, the request for execution by the respective autonomous vehicle is denied. If the estimated time periods satisfy a predefined threshold or predefined time constraints, at block 1112 the request for execution by the respective autonomous vehicle is accepted and a command is sent to the autonomous vehicle at block 1120. The command instructs the autonomous vehicle to execute routes associated with the requests. In response, the autonomous vehicle begins navigation to execute the requests.

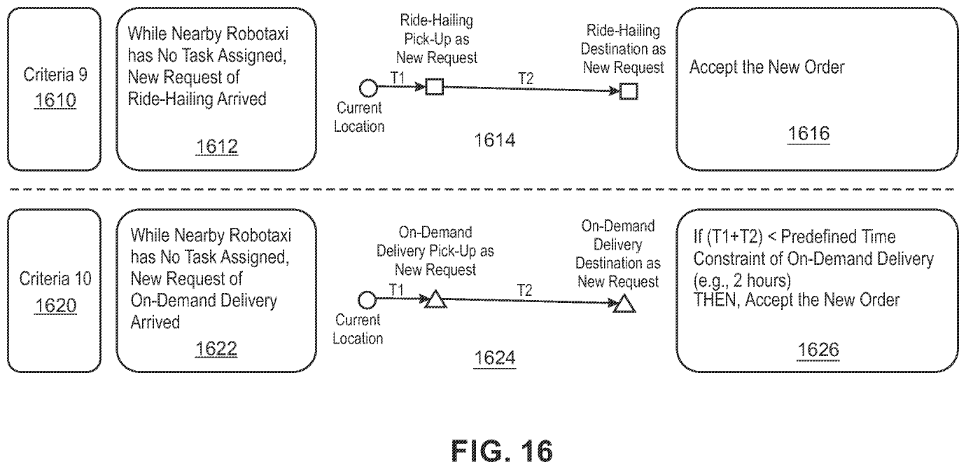

In some embodiments, the decision criteria include an ETA comparison, predefined time constraints (e.g., grocery goods should be delivered within 2 hours from the pick-up), thresholds, and client input. The decision criteria may vary for each state as defined by the state machine 1104. As illustrated in FIG. 11, the decision criteria evaluator 1108 selects the applicable decision criteria based on the received request type 1122 and nearby vehicle state 1124. Viewing the decision criteria evaluator 1108 as a grid, a ride hailing request is denied when the nearby vehicle is in State A or State B. A ride hailing request is evaluated using criteria 1 (e.g., 1210 of FIG. 12) when the nearby vehicle state is in State C, and using decision criteria 2 (e.g., 1220 of FIG. 12) when the nearby vehicle state is in State D. A ride hailing request is denied when the nearby vehicle is in State E, F, or G. A ride hailing request evaluated using decision criteria 9 (e.g., 1610 of FIG. 16) when the nearby vehicle is in State H.

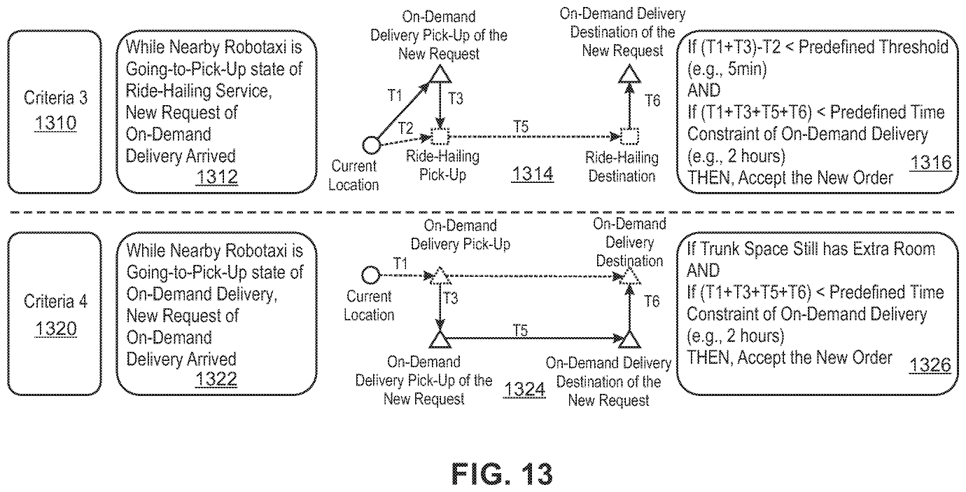

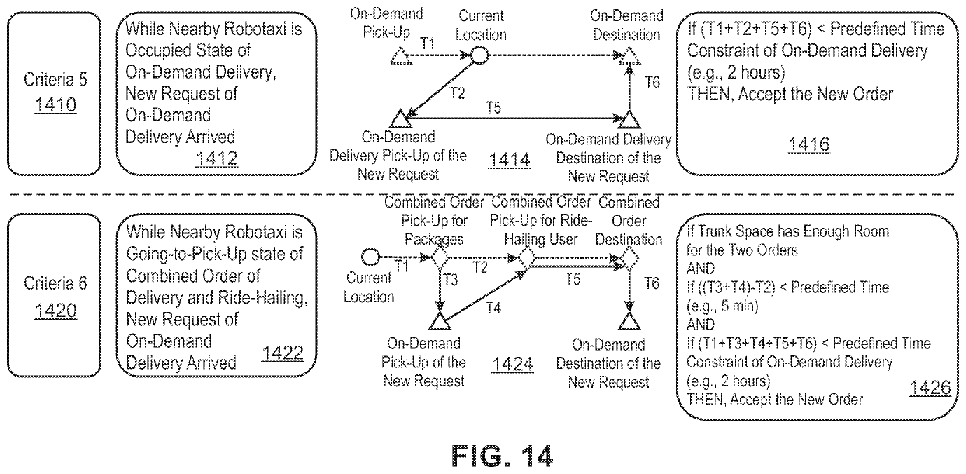

Similarly, an on-demand delivery request is evaluated using decision criteria 3 (e.g., 1310 of FIG. 13) when the nearby vehicle is in State A. The on-demand delivery request is denied when the nearby vehicle is in State B. The on-demand delivery request type is evaluated using decision criteria 4 (e.g., 1320 of FIG. 13) when the nearby vehicle is in State C. The on-demand delivery request type is evaluated using decision criteria 5 (e.g., 1410 of FIG. 14) when the nearby vehicle is in State D. The on-demand delivery request type is denied when the nearby vehicle is in State F or G. The on-demand delivery is evaluated using decision criteria 10 (e.g., 1610 of FIG. 16) when the nearby vehicle is in State H.

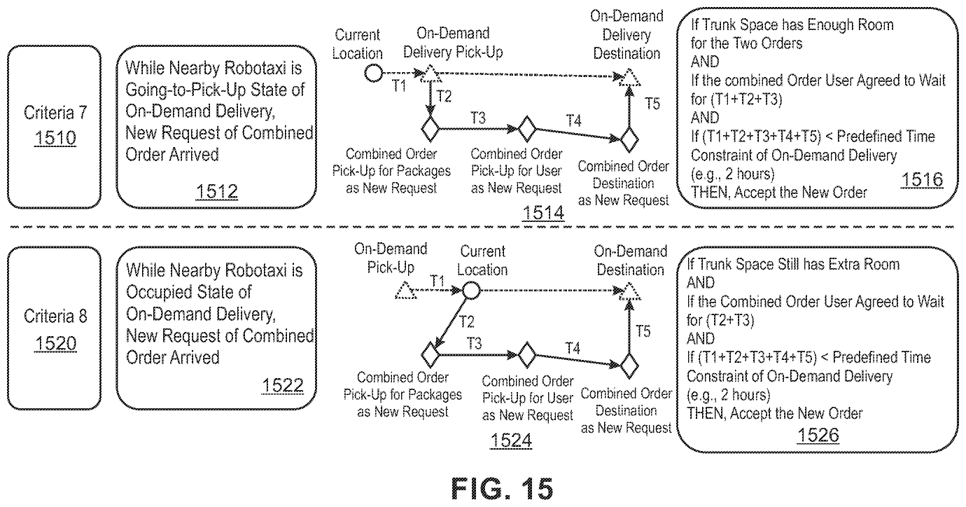

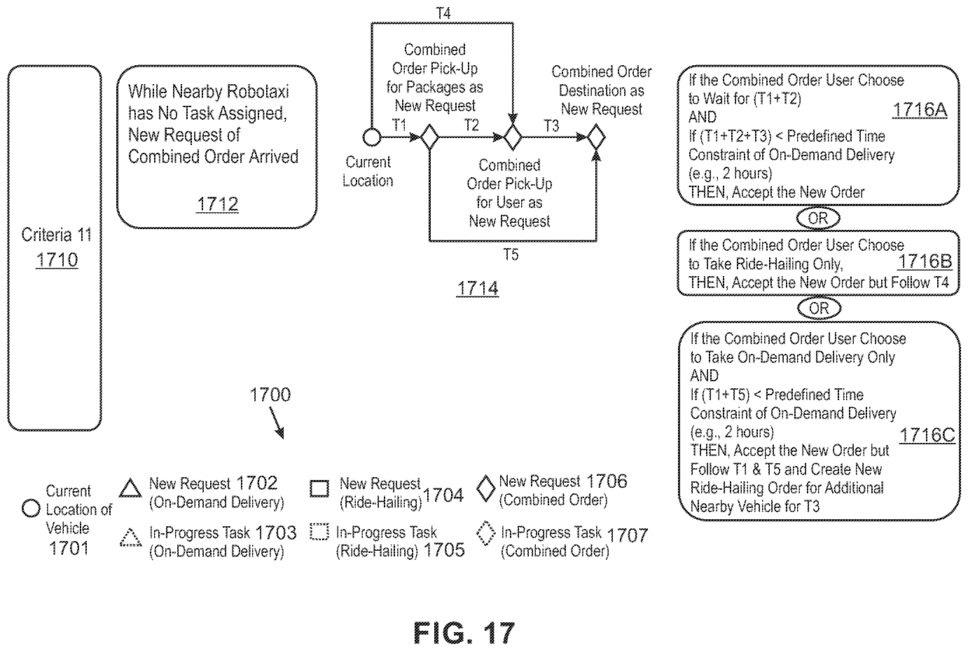

Similarly, a combined order request denied when the nearby vehicle is in State A or B. The combined order request is evaluated using decision criteria 7 (e.g., 1510 of FIG. 15) when the nearby vehicle is in State C. The combined order request is evaluated using decision criteria 8 (e.g., 1520 of FIG. 8) when the nearby vehicle is in State D. The combined order request is denied when the nearby vehicle is in State E, F, or G. The combined order request is evaluated using decision criteria 11 (e.g., 1710 of FIG. 17) when the nearby vehicle is in State H.

FIGS. 12-17 illustrate evaluation of decision criteria 1-11. Generally, in FIGS. 12-17, for each criteria a situation is provided that describes the state and request types, if any. A proposed route for the vehicle to execute the requests is presented, with estimated time intervals (e.g., T1-T6) to complete the legs of the route. For each respective criteria, predefined time constraints and thresholds are applied to the estimated time intervals to determine if the requests are accepted for execution by the vehicle.

The decision criteria described with respect to FIGS. 12-17 are exemplary and the present techniques are not limited to the decision criteria described herein. To evaluate proposed routes, a legend 1700 is provided in FIG. 17. The legend 1700 applies to the proposed routes illustrated in FIGS. 12-17. A current location of the vehicle 1701 (e.g., autonomous vehicle of the fleet) is represented by a circle. A new request for on-demand delivery 1702 is represented using a solid line triangle. A new request for ride hailing 1704 is represented by a solid line square. A new request for a combined order 1706 is represented by a solid line diamond. An in progress task for on-demand delivery is represented by a dashed line triangle 1703. An in progress task for ride hailing 1705 is represented by dashed line square, and in progress task for a combined order 1707 is represented by a dashed line diamond. The decision criteria are based on predefined time constraints and predefined thresholds applied to proposed routes associated with the new request. In examples, a predefined time constraint represents a time constraint applicable to the complete execution of the new request. Additionally, in examples, a predefined time threshold represents a time threshold applied to segments of a proposed route associated with a ride request.

FIG. 12 illustrates criteria 1 (1210). In the example of criteria 1 (1210), while a nearby vehicle (e.g., robo-taxi) is in a going-to-pick-up state of on-demand delivery (e.g., State C of FIG. 11), new request for ride hailing is received as described in the associated situation 1212. The proposed route 1214 begins at a current location, and time interval T1 represents the length of time for the vehicle to navigate from the currently location to the on-demand delivery pickup location. A time interval T2 represents the length of time for the vehicle to navigate from the current location to the ride hailing pickup location associated with the new request. A time interval T3 represents the length of time for the vehicle to navigate from the on-demand delivery pickup location to the ride hailing location associated with the new request. A time interval T5 represents the length of time for the vehicle to navigate from the ride hailing pickup location associated with the new request and the ride hailing destination associated with the new request. A time interval T6 represents a length of time for the vehicle to navigate from the ride hailing destination location to the on-demand delivery destination. For criteria 1, the new request is accepted if the following is true:

(T1+T3)−T2<predefined threshold EQ. 1A

### AND

(T1+T3+T5+T6)<predefined time constraint of on−demand delivery EQ. 1B

As shown in the evaluation 1216, a predefined threshold is, for example, five minutes. In some embodiments, a predefined time constraint applicable to on-demand delivery is, for example, 2 hours. As shown at criteria 1 (1210) of FIG. 12, if Equation 1A and Equation 1B are true, the new ride request is accepted and the vehicle executes the ride request. The Equations 1A and 1B determines how much additional time it would take to service the new requests in view of a current state of the vehicle. If Equation 1A or Equation 1B is false, the new ride request is denied.

FIG. 12 illustrates criteria 2 (1220). In the example of criteria 2 (1220), while a nearby vehicle (e.g., robo-taxi) is occupied in a state of on-demand delivery (e.g., State D of FIG. 11), new request for ride hailing is received as described in the associated situation 1222. The proposed route 1224 begins at a current location, and time interval T1 represents the length of time for the vehicle to navigate from the current location to the on-demand delivery pickup location. A time interval T2 represents the length of time for the vehicle to navigate from the current location to the ride hailing pickup location associated with the new request. A time interval T5 represents the length of time for the vehicle to navigate from the ride hailing pickup location associated with the new request to the ride hailing destination associated with the new request. A time interval T6 represents a length of time for the vehicle to navigate from the ride hailing destination location to the on-demand delivery destination. For criteria 1, the new request is accepted if the following is true:

T2<predefined threshold EQ. 2A

### AND

(T1+T2+T5+T6)<predefined time constraint of on−demand delivery EQ. 2B

As shown in the evaluation 1226, a predefined threshold is, for example, seven minutes. In some embodiments, a predefined time constraint applicable to on-demand delivery is, for example, 2 hours. As shown at criteria 2 (1222) of FIG. 12, if Equation 2A and Equation 2B are true, the new ride request is accepted and the vehicle executes the ride request. If Equation 2A or Equation 2B is false, the new ride request is denied. In the example of criteria 2 (1220), if a person hails a robo-taxi and indicates that they would like to use the trunk or cargo area, that vehicle is unavailable for trunk delivery (simultaneous trunk delivery) since the trunk is occupied. For example, if a ride hailing passenger requests a ride after grocery shopping and indicates that the trunk is needed to transport the groceries purchased by the rider, and that vehicle is unable to provide further trunk delivery services. In some embodiments, a second storage area is provided in the vehicle so that multiple trunk delivery requests can be serviced. In a second storage area is available, the vehicle is able to service a ride hailing passenger with trunk storage requirements as well as a grocery delivery. If the vehicle includes multiple storage areas, multiple grocery deliveries can be serviced along with a ride hailing request. In some cases, a second vehicle with an empty trunk is used when a first vehicle is unavailable due to a ride hailing passenger with trunk storage requirements.

FIG. 13 illustrates criteria 3 (1310). In the example of criteria 3 (1310), while a nearby vehicle is in a going-to pick-up state of ride-hailing service (e.g., State A), a new request of on-demand delivery is received as described in the associated situation 1312. The proposed route 1314 begins at a current location, and time interval T1 represents the length of time for the vehicle to navigate from the current location to the on-demand delivery pickup location. A time interval T2 represents the length of time for the vehicle to navigate from the current location to the ride hailing pickup location associated with the new request. A time interval T3 represents the length of time for the vehicle to navigate from the on-demand delivery pickup location to the ride hailing starting location associated with the new request. A time interval T5 represents the length of time for the vehicle to navigate from the ride hailing pickup location associated with the new request to the ride hailing destination associated with the new request. A time interval T6 represents a length of time for the vehicle to navigate from the ride hailing destination location to the on-demand delivery destination associated with the new request. For criteria 3, the new request is accepted if the following is true:

(T1+T3)−T2 <predefined threshold EQ. 3A

### AND

(T1+T3+T5+T6)<predefined time constraint of on−demand delivery EQ. 3B

As shown in the evaluation 1316, a predefined threshold is, for example, five minutes. In some embodiments, a predefined time constraint applicable to on-demand delivery is, for example, 2 hours. As shown at criteria 3 (1310) of FIG. 13, if Equation 3A and Equation 3B are true, the on-demand delivery request is accepted and the vehicle executes the on-demand delivery request. If Equation 3A or Equation 3B is false, the new on-demand delivery is denied.

FIG. 13 illustrates criteria 4 (1320). In the example of criteria 4 (1320), while a nearby vehicle is in a going-to-pickup state of on-demand delivery (e.g., State C of FIG. 11), new request of on-demand delivery arrived is received as described in the associated situation 1322. The proposed route 1324 begins at a current location, and time interval T1 represents the length of time for the vehicle to navigate from the current location to the on-demand delivery pickup location. A time interval T3 represents the length of time for the vehicle to navigate from the on-demand delivery pickup location to the ride hailing starting location associated with the new request. A time interval T5 represents the length of time for the vehicle to navigate from the ride hailing pickup location associated with the new request to the ride hailing destination associated with the new request. A time interval T6 represents a length of time for the vehicle to navigate from the ride hailing destination location to the on-demand delivery destination associated with the new request. For criteria 4, the new request is accepted if the trunk space is available (e.g., trunk space determinator 1110 of FIG. 11) AND the following is true:

T1+T3+T5+T6<predefined threshold EQ. 4A

As shown in the evaluation 1326, a predefined time constraint applicable to on-demand delivery is, for example, 2 hours. As shown at criteria 4 (1320) of FIG. 13, if the trunk space determinator indicates cargo space is available and Equation 4A are true, the new on-demand delivery request is accepted and the vehicle executes the on-demand delivery request. If no cargo space is available or Equation 4A is false, the on-demand delivery request is denied.

FIG. 14 illustrates criteria 5 (1410). In the example of criteria 5 (1520), while a nearby vehicle is in a occupied state of on-demand delivery (e.g., State D of FIG. 11), new request for on-demand delivery is received as described in the associated situation 1412. The proposed route 1414 begins at a current location, and time interval T1 represents the length of time for the vehicle to navigate from the current location to the on-demand delivery pickup location. A time interval T2 represents the length of time for the vehicle to navigate from the current location to the on-demand delivery pickup location associated with the new request. A time interval T5 represents the length of time for the vehicle to navigate from the on-demand delivery pickup location associated with the new request to the on-demand delivery destination associated with the new request. A time interval T6 represents a length of time for the vehicle to navigate from the on-demand delivery destination location associated with the new request to the on-demand delivery destination. For criteria 5, the new request is accepted the following is true:

T1+T2+T5+T6<predefined threshold EQ. 5A

As shown in the evaluation 1416, a predefined time constraint applicable to on-demand delivery is, for example, 2 hours. If Equation 5A is true, the new on-demand delivery request is accepted and the vehicle executes the on-demand delivery request. If Equation 5A is false, the on-demand delivery request is denied.

FIG. 14 illustrates criteria 6 (1420). In the example of criteria 6 (1420), while the nearby vehicle is in a going-to pickup state of a combined order of delivery and ride-hailing (e.g., State E of FIG. 11), a new request for on-demand delivery is received as described in the associated situation 1422. The proposed route 1424 begins at a current location, and time interval T1 represents the length of time for the vehicle to navigate from the current location to the combined order pickup location for packages. A time interval T2 represents the length of time for the vehicle to navigate from combined order pickup location for packages to a combined order pickup location for a ride hailing user. A time interval T3 represents the length of time for the vehicle to navigate from the combined order pickup location for packages to the on-demand pickup location of the new request. A time interval T4 represents the length of time for the vehicle to navigate from the on-demand pickup location associated with the new request to the combined order pickup location for a ride hailing user. A time interval T5 represents the length of time for the vehicle to navigate from the combined order pickup location for the ride haling user to the combined order destination. A time interval T6 represents a length of time for the vehicle to navigate from the combined order destination to the on-demand destination of the new request. For criteria 6, the new request is accepted if trunk space is available the following are true:

(T3+T4)−T2<predefined threshold EQ. 6A

### AND

(T1+T3+T4+T5+T6)<predefined time constraint of on−demand delivery EQ. 6B

As shown in the evaluation 1426, a predefined time constraint applicable to on-demand delivery is, for example, 2 hours. If trunk space is available, and Equations 6A and 6B are true, the new on-demand delivery request is accepted and the vehicle executes the on-demand delivery request. If there is no trunk space available, or one of Equations 6A or 6B is false, the on-demand delivery request is denied.

FIG. 15 illustrates criteria 7 (1510). In the example of criteria 7 (1510), while the nearby vehicle is in a going-to pickup state of on-demand delivery (e.g., State C of FIG. 11), a new request for combined order delivery is received as described in the associated situation 1512. The proposed route 1514 begins at a current location, and time interval T1 represents the length of time for the vehicle to navigate from the current location to the on-demand pickup location. A time interval T2 represents the length of time for the vehicle to navigate from the on-demand pickup location to a combined order pickup location for packages as a new request. A time interval T3 represents the length of time for the vehicle to navigate from the combined order pickup location for packages as a new request to the combined order pickup location for a user of the new request. A time interval T4 represents the length of time for the vehicle to navigate from the combined order pickup location for a user of the new request to the combined order destination of the new request. A time interval T5 represents the length of time for the vehicle to navigate from the combined order destination of the new request to the on-demand delivery destination. For criteria 7, the new request is accepted if trunk space is available for two orders the following are true:

User agrees to wait for a time interval=(T1+T2+T3) EQ. 7A

### AND

(T1+T2+T3+T4+T5)<predefined time constraint of on−demand delivery EQ. 7B

As shown in the evaluation 1516, a predefined time constraint applicable to on-demand delivery is, for example, 2 hours. If trunk space is available, and Equations 7A and 7B are true, the new combined order delivery request is accepted and the vehicle executes the combined order delivery request. If there is no trunk space available, or either of Equations 7A or 7B is false, the on-demand delivery request is denied.

FIG. 15 illustrates criteria 8 (1520). In the example of criteria 8 (1520), while the nearby vehicle is in an occupied state of on-demand delivery (e.g., State D of FIG. 11), a new request of combined order delivery is received as described in the associated situation 1522. The proposed route 1524 begins at a current location, and time interval T1 represents the length of time for the vehicle to navigate from the on-demand pickup location to the current location. A time interval T2 represents the length of time for the vehicle to navigate from the current location to a combined order pickup location for packages as a new request. A time interval T3 represents the length of time for the vehicle to navigate from the combined order pickup location for packages as a new request to the combined order pickup location for a user of the new request. A time interval T4 represents the length of time for the vehicle to navigate from the combined order pickup location for a user of the new request to the combined order destination of the new request. A time interval T5 represents the length of time for the vehicle to navigate from the combined order destination of the new request to the on-demand delivery destination. For criteria 8, the new request is accepted if trunk space is available and following are true:

User agrees to wait for a time interval=(T2+T3) EQ. 8A

### AND

(T1+T2+T3+T4+T5)<predefined time constraint of on−demand delivery EQ. 8B

As shown in the evaluation 1526, a predefined time constraint applicable to on-demand delivery is, for example, 2 hours. If trunk space is available, and Equations 8A and 8B are true, the new combined order delivery request is accepted and the vehicle executes the combined order delivery request. If there is no trunk space available, or if either of Equations 8A or 8B is false, the on-demand delivery request is denied.

FIG. 16 illustrates criteria 9 (1610). In the example of criteria 9 (1610), while the nearby vehicle has no task assigned (e.g., State H of FIG. 11), a new request of ride-hailing is received as described in the associated situation 1612. The proposed route 1614 begins at a current location, and time interval T1 represents the length of time for the vehicle to navigate from the current location to the ride hailing pickup location as a new request. A time interval T2 represents the length of time for the vehicle to navigate from the ride hailing pickup location as a new request to the ride hailing destination location as a new request. For criteria 9, the new request is accepted upon receipt.

FIG. 16 illustrates criteria 10 (1620). In the example of criteria 10 (1620), while the nearby vehicle has no task assigned (e.g., State H of FIG. 11), a new request on-demand delivery is received as described in the associated situation 1622. The proposed route 1624 begins at a current location, and time interval T1 represents the length of time for the vehicle to navigate from the current location to the on-demand pickup location as a new request. A time interval T2 represents the length of time for the vehicle to navigate from the on-demand delivery pickup location as a new request to the on-demand delivery destination location as a new request. For criteria 10, the new request is accepted if the following is true:

(T1+T2)<predefined time constraint of on−demand delivery EQ. 10A

As shown in the evaluation 1626, a predefined time constraint applicable to on-demand delivery is, for example, 2 hours. If Equation 10A is true, the new combined order delivery request is accepted and the vehicle executes the on-demand delivery request. If Equation 10A is false, the on-demand delivery request is denied.

FIG. 17 illustrates criteria 11 (1710). In the example of criteria 11 (1710), while the nearby vehicle has no task assigned (e.g., State H of FIG. 11), a new request for a combined order is received as described in the associated situation 1712. The proposed route 1714 begins at a current location, and time interval T1 represents the length of time for the vehicle to navigate from the current location to the combined order pickup location for packages as a new request. A time interval T2 represents the length of time for the vehicle to navigate from the combined order pickup location for packages to the combined order pickup location for a user as a new request. A time interval T3 represents the length of time for the vehicle to navigate from the combined order pickup location for a user as a new request to the combined order destination location as a new request. A time interval T4 represents the length of time for the vehicle to navigate from the current location the combined order pickup location for a user as a new request. A time interval T5 represents the length of time for the vehicle to navigate from the combined order pickup location for packages as a new request to the combined order destination as a new request. For criteria 11, the new request is accepted if the following is true:

User agrees to wait for a time interval=(T1+T2) EQ. 11A

### AND

(T1+T2+T3)<predefined time constraint of on−demand delivery EQ. 11B

As shown in the evaluation 1716A, a predefined time constraint applicable to on-demand delivery is, for example, 2 hours. If Equations 11A and 11B are true, the new combined order delivery request is accepted and the vehicle executes the combined order delivery request. If Equation 11A or 11B is false, the on-demand delivery request is denied.

In a first alternative, for criteria 11, the new request is accepted if the combined order selects ride-hailing only as shown in the evaluation 1716B. In a second alternative, for criteria 11, the new request is accepted if the combined order user selects on demand delivery only and the following is true:

(T1+T5)<predefined time constraint of on−demand delivery EQ. 11C

As shown in the evaluation 1716C, a predefined time constraint applicable to on-demand delivery is, for example, 2 hours. If Equation 11C is true, the new combined order delivery request is accepted and the vehicle follows T1 and T5 and created a new ride hailing order for additional nearby vehicle T3. If Equation 11C is false, the on-demand delivery request is denied.

FIGS. 12-17 provide guidance on the acceptance of additional requests affect the total delivery time. If the additional requests cause routes that do not comply with the criteria, the requests are declined. For example, consider a case where a vehicle is in State A of FIG. 11, navigating to a starting location of the ride request to pick up a passenger and a delivery request is received. As described with respect to criteria 3 (1310), if the time taken to go pick up the delivery and then pick up the client exceeds a predetermined constraint or threshold, the request is declined. In an example, the delivery request is declined and the client is picked up because the client has priority (or an associated time limit and cannot be exceeded) and the amount of time it would take to pick up the delivery could violate the client's priority.

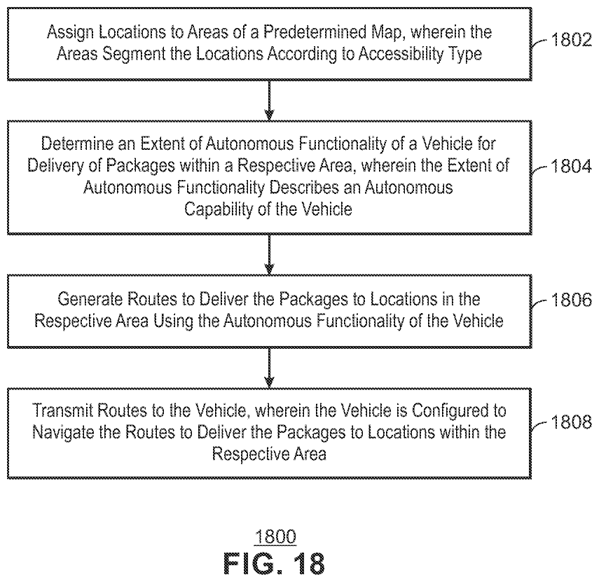

FIG. 18 is a process flow diagram of a process 1800 for delivery fleet management. In some embodiments, the process 1800 is implemented (e.g., completely, partially, etc.) using an AV system that is the same as or similar to AV system 114, described in reference to FIG. 1. In some embodiments, the process 1800 is implemented (e.g., completely, partially, etc.) using a fleet management system 116, described in reference to FIG. 1. In some embodiments, the process 1800 is implemented (e.g., completely, partially, and/or the like) by a device that is the same as or similar to the device 300 of FIG. 3. In some embodiments, the process 1800 includes any of the above-noted systems in cooperation with one another. In some embodiments, the device 1800 is a personal device (e.g., smart phone, tablet, laptop, etc.).

At block 1802, delivery locations of packages are assigned to areas of a predetermined map, wherein the areas segment the delivery locations according to accessibility types.

At block 1804, an extent of autonomous functionality of a vehicle is determined for delivery of the packages within a respective area, wherein the extent of autonomous functionality describes an autonomous capability of the vehicle.

At block 1806, routes are generated to deliver the packages using the autonomous functionality of the vehicle within the respective area.

At block 1806, the routes are transmitted to the vehicle, wherein the vehicle is configured to navigate the routes to deliver the packages to the delivery locations.

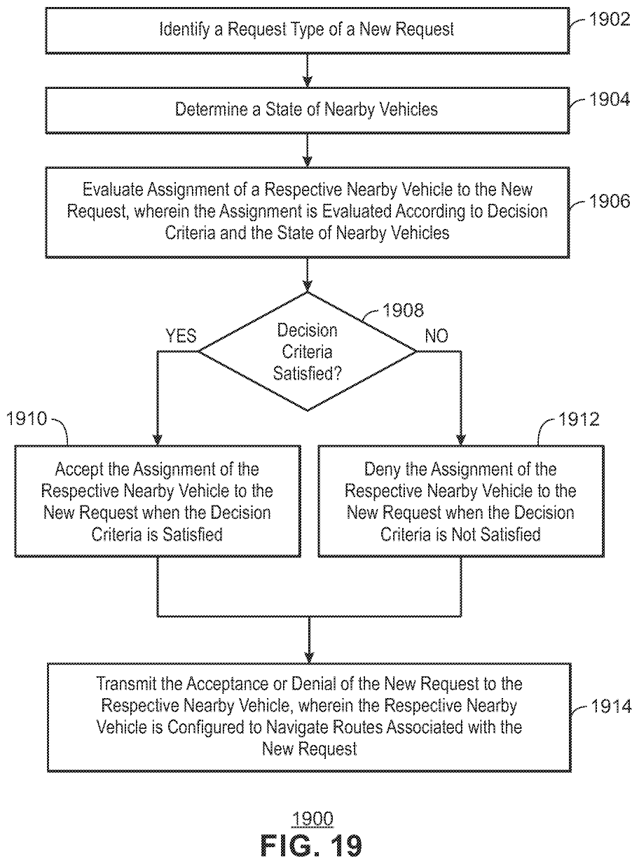

FIG. 19 is a process flow diagram of a process 1900 for delivery fleet management with ride requests. In some embodiments, the process 1900 is implemented (e.g., completely, partially, etc.) using an AV system that is the same as or similar to AV system 114, described in reference to FIG. 1. In some embodiments, the process 1900 is implemented (e.g., completely, partially, etc.) using a fleet management system 116, described in reference to FIG. 1. In some embodiments, the process 1900 is implemented (e.g., completely, partially, and/or the like) by a device that is the same as or similar to the device 300 of FIG. 3. In some embodiments, the process 1900 includes any of the above-noted systems in cooperation with one another. In some embodiments, the device 1900 is a personal device (e.g., smart phone, tablet, laptop, etc.).

At block 1902, a request type of a new request is identified.

At block 1904, a state of nearby vehicles is determined, wherein the nearby vehicles are located within a predetermined radius around locations identified in the new request.

At block 1906, an assignment of a respective nearby vehicle to the new request is evaluated, wherein the assignment is evaluated according to decision criteria and the state of nearby vehicles;

At block 1908, it is determined if the decision criteria is satisfied. If the decision criteria is satisfied, process flow continues to block 1910. At block 1910, the assignment of the respective nearby vehicle to the new request is accepted when the decision criteria is satisfied.

If the decision criteria is not satisfied, process flow continues to block 1912.

At block 1912, the assignment of the respective nearby vehicle to the new request is denied when the decision criteria is not satisfied.

At block 1914, the acceptance or denial of the new request is transmitted to the respective nearby vehicle, wherein the respective nearby vehicle is configured to navigate routes associated with the new request.

According to some non-limiting embodiments or examples, provided is a method, comprising: assigning, using at least one processor, delivery locations of packages to areas of a predetermined map, wherein the areas segment the delivery locations according to accessibility types; determining, using the at least one processor, an extent of autonomous functionality of a vehicle for delivery of the packages within a respective area, wherein the extent of autonomous functionality describes an autonomous capability of the vehicle; generating, using the at least one processor, routes to deliver the packages using the autonomous functionality of the vehicle within the respective area; and transmitting, using the at least one processor, the routes to the vehicle, wherein the vehicle is configured to navigate the routes to deliver the packages at the delivery locations.

According to some non-limiting embodiments or examples, provided is a system, comprising: at least one processor, and at least one non-transitory storage media storing instructions that, when executed by the at least one processor, cause the at least one processor to: assign delivery locations of packages to areas of a predetermined map, wherein the areas segment the delivery locations according to accessibility types; determine an extent of autonomous functionality of a vehicle for delivery of the packages within a respective area, wherein the extent of autonomous functionality describes an autonomous capability of the vehicle; generate routes to deliver the packages using the autonomous functionality of the vehicle within the respective area; and transmit the routes to the vehicle, wherein the vehicle is configured to navigate the routes to deliver the packages at the delivery locations.

According to some non-limiting embodiments or examples, provided is at least one non-transitory storage media storing instructions that, when executed by at least one processor, cause the at least one processor to: assign delivery locations of packages to areas of a predetermined map, wherein the areas segment the delivery locations according to accessibility types; determine an extent of autonomous functionality of a vehicle for delivery of the packages within a respective area, wherein the extent of autonomous functionality describes an autonomous capability of the vehicle; generate routes to deliver the packages using the autonomous functionality of the vehicle within the respective area; and transmit the routes to the vehicle, wherein the vehicle is configured to navigate the routes to deliver the packages at the delivery locations.

According to some non-limiting embodiments or examples, provided is a method, comprising: identifying, using at least one processor, a request type of a new request; determining, using the at least one processor, a state of nearby vehicles, wherein the nearby vehicles are located within a predetermined radius around locations identified in the new request; evaluating, using the at least one processor, an assignment of a respective nearby vehicle to the new request, wherein the assignment is evaluated according to decision criteria and the state of nearby vehicles; accepting, using the at least one processor, the assignment of the respective nearby vehicle to the new request when the decision criteria is satisfied; denying, using the at least one processor, the assignment of the respective nearby vehicle to the new request when the decision criteria is not satisfied; and transmitting, using the at least one processor, the acceptance or denial of the new request to the respective nearby vehicle, wherein the respective nearby vehicle is configured to navigate routes associated with the new request.

According to some non-limiting embodiments or examples, provided is a system, comprising: at least one processor, and at least one non-transitory storage media storing instructions that, when executed by the at least one processor, cause the at least one processor to: identify a request type of a new request; determine a state of nearby vehicles, wherein the nearby vehicles are located within a predetermined radius around locations identified in the new request; evaluate an assignment of a respective nearby vehicle to the new request, wherein the assignment is evaluated according to decision criteria and the state of nearby vehicles; accept the assignment of the respective nearby vehicle to the new request when the decision criteria is satisfied; deny the assignment of the respective nearby vehicle to the new request when the decision criteria is not satisfied; an transmit the acceptance or denial of the new request to the respective nearby vehicle, wherein the respective nearby vehicle is configured to navigate routes associated with the new request.

According to some non-limiting embodiments or examples, provided is at least one non-transitory storage media storing instructions that, when executed by at least one processor, cause the at least one processor to: identify a request type of a new request; determine a state of nearby vehicles, wherein the nearby vehicles are located within a predetermined radius around locations identified in the new request; evaluate an assignment of a respective nearby vehicle to the new request, wherein the assignment is evaluated according to decision criteria and the state of nearby vehicles; accept the assignment of the respective nearby vehicle to the new request when the decision criteria is satisfied; deny the assignment of the respective nearby vehicle to the new request when the decision criteria is not satisfied; and transmit the acceptance or denial of the new request to the respective nearby vehicle, wherein the respective nearby vehicle is configured to navigate routes associated with the new request.

Further non-limiting embodiments or examples are set forth in the following numbered clauses:

Clause 1. A method, comprising: assigning, using at least one processor, delivery locations of packages to areas of a predetermined map, wherein the areas segment the delivery locations according to accessibility types; determining, using the at least one processor, an autonomous functionality of a vehicle for delivery of the packages within a respective area, wherein the autonomous functionality describes an autonomous capability of the vehicle; generating, using the at least one processor, routes to deliver the packages using the autonomous functionality of the vehicle within the respective area; and transmitting, using the at least one processor, the routes to the vehicle, wherein the vehicle is configured to navigate the routes to deliver the packages at the delivery locations.

Clause 2: The method of clause 1, wherein the delivery location is assigned to an area of a predetermined map based on the accessibility type and an accessibility sub-category.

Clause 3: The method of any one of the preceding clauses, wherein the autonomous functionality of the vehicle for delivery of the package includes the presence or lack of a delivery device.

Clause 4: The method of any one of the preceding clauses, wherein the respective area comprises delivery infrastructures and the autonomous functionality of the vehicle for delivery of the packages in the area is fully autonomous, without a human driver.

Clause 5: The method of any one of the preceding clauses, wherein the respective area is a robot deliverable area and the autonomous functionality of the vehicle for delivery of the packages in the area is fully autonomous, without a human driver.

Clause 6: The method of clause 5, wherein the autonomous functionality of the vehicle comprises a delivery device that enables autonomous final step delivery.

Clause 7: The method of any one of the preceding clauses, wherein the respective area is a robot cannot deliver area and the autonomous functionality of the vehicle for delivery of the packages in the area is fully autonomous, without a human driver.

Clause 8: The method of any one of the preceding clauses, wherein the respective area is a robot cannot deliver area and the autonomous functionality of the vehicle for delivery of the packages in the area is fully autonomous with a delivery worker that enables human supported final step delivery.

Clause 9: The method of any one of the preceding clauses, wherein the vehicle is a member of a ride hailing fleet, and the packages are delivered via trunk delivery.

Clause 10: The method of any one of the preceding clauses, wherein the vehicle is operable to navigate routes to deliver the packages at the delivery locations in a driverless shuttle mode, wherein a human delivery worker delivers packages from the vehicle to a respective delivery area.

Clause 11: The method of any one of the preceding clauses, wherein the vehicle is operable to navigate routes to deliver the packages at the delivery locations in a train mode, wherein the vehicle is one of a train of vehicles and a human delivery worker delivers packages from the train of vehicles to a respective delivery area.

Clause 12: A system, comprising: at least one processor, and at least one non-transitory storage media storing instructions that, when executed by the at least one processor, cause the at least one processor to: assign delivery locations of packages to areas of a predetermined map, wherein the areas segment the delivery locations according to accessibility types; determine an autonomous functionality of a vehicle for delivery of the packages within a respective area, wherein the autonomous functionality describes an autonomous capability of the vehicle; generate routes to deliver the packages using the autonomous functionality of the vehicle within the respective area; and transmit the routes to the vehicle, wherein the vehicle is configured to navigate the routes to deliver the packages at the delivery locations.

Clause 13: The system of clause 12, wherein the delivery location is assigned to an area of a predetermined map based on the accessibility type and an accessibility sub-category.

Clause 14: The system of any one of the preceding clauses, wherein the autonomous functionality of the vehicle for delivery of the package includes the presence or lack of a delivery device.

Clause 15: The system of any one of the preceding clauses, wherein the respective area comprises delivery infrastructures and the autonomous functionality of the vehicle for delivery of the packages in the area is fully autonomous, without a human driver.

Clause 16: The system of any one of the preceding clauses, wherein the respective area is a robot deliverable area and the autonomous functionality of the vehicle for delivery of the packages in the area is fully autonomous, without a human driver.

Clause 17: The system of clause 16, wherein the autonomous functionality of the vehicle comprises a delivery device that enables autonomous final step delivery.

Clause 18: The system of any one of the preceding clauses, wherein the respective area is a robot cannot deliver area and the autonomous functionality of the vehicle for delivery of the packages in the area is fully autonomous, without a human driver.

Clause 19: The system of any one of the preceding clauses, wherein the respective area is a robot cannot deliver area and the autonomous functionality of the vehicle for delivery of the packages in the area is fully autonomous with a delivery worker that enables human supported final step delivery.

Clause 20: The system of any one of the preceding clauses, wherein the vehicle is a member of a ride hailing fleet, and the packages are delivered via trunk delivery.

Clause 21: The system of any one of the preceding clauses, wherein the vehicle is operable to navigate routes to deliver the packages at the delivery locations in a driverless shuttle mode, wherein a human delivery worker delivers packages from the vehicle to a respective delivery area.

Clause 22: The system of any one of the preceding clauses, wherein the vehicle is operable to navigate routes to deliver the packages at the delivery locations in a train mode, wherein the vehicle is one of a train of vehicles and a human delivery worker delivers packages from the train of vehicles to a respective delivery area.

Clause 23: At least one non-transitory storage media storing instructions that, when executed by at least one processor, cause the at least one processor to: assign delivery locations of packages to areas of a predetermined map, wherein the areas segment the delivery locations according to accessibility types; determine an autonomous functionality of a vehicle for delivery of the packages within a respective area, wherein the autonomous functionality describes an autonomous capability of the vehicle; generate routes to deliver the packages using the autonomous functionality of the vehicle within the respective area; and transmit the routes to the vehicle, wherein the vehicle is configured to navigate the routes to deliver the packages at the delivery locations.

Clause 24: The least one non-transitory storage media of clause 23, wherein the delivery location is assigned to an area of a predetermined map based on the accessibility type and an accessibility sub-category.

Clause 25: The least one non-transitory storage media of any one of the preceding clauses, wherein the autonomous functionality of the vehicle for delivery of the package includes the presence or lack of a delivery device.

Clause 26: The least one non-transitory storage media of any one of the preceding clauses, wherein the respective area comprises delivery infrastructures and the autonomous functionality of the vehicle for delivery of the packages in the area is fully autonomous, without a human driver.

Clause 27: The least one non-transitory storage media of any one of the preceding clauses, wherein the respective area is a robot deliverable area and the autonomous functionality of the vehicle for delivery of the packages in the area is fully autonomous, without a human driver.

Clause 28: The least one non-transitory storage media of clause 27, wherein the autonomous functionality of the vehicle comprises a delivery device that enables autonomous final step delivery.

Clause 29: The least one non-transitory storage media of any one of the preceding clauses, wherein the respective area is a robot cannot deliver area and the autonomous functionality of the vehicle for delivery of the packages in the area is fully autonomous, without a human driver.

Clause 30: The least one non-transitory storage media of any one of the preceding clauses, wherein the respective area is a robot cannot deliver area and the autonomous functionality of the vehicle for delivery of the packages in the area is fully autonomous with a delivery worker that enables human supported final step delivery.

Clause 31: The least one non-transitory storage media of any one of the preceding clauses, wherein the vehicle is a member of a ride hailing fleet, and the packages are delivered via trunk delivery.

Clause 32: The least one non-transitory storage media of any one of the preceding clauses, wherein the vehicle is operable to navigate routes to deliver the packages at the delivery locations in a driverless shuttle mode, wherein a human delivery worker delivers packages from the vehicle to a respective delivery area.

Clause 33: The least one non-transitory storage media of any one of the preceding clauses, wherein the vehicle is operable to navigate routes to deliver the packages at the delivery locations in a train mode, wherein the vehicle is one of a train of vehicles and a human delivery worker delivers packages from the train of vehicles to a respective delivery area.

Clause 34: A method, comprising: identifying, using at least one processor, a request type of a new request; determining, using the at least one processor, a state of nearby vehicles, wherein the nearby vehicles are located within a predetermined radius around locations identified in the new request; evaluating, using the at least one processor, an assignment of a respective nearby vehicle to the new request, wherein the assignment is evaluated according to decision criteria and the state of nearby vehicles; accepting, using the at least one processor, the assignment of the respective nearby vehicle to the new request when the decision criteria is satisfied; denying, using the at least one processor, the assignment of the respective nearby vehicle to the new request when the decision criteria is not satisfied; and transmitting, using the at least one processor, the acceptance or denial of the new request to the respective nearby vehicle, wherein the respective nearby vehicle is configured to navigate routes associated with the new request.

Clause 35: The method of clause 34, wherein the request type is a ride hailing request, an on-demand delivery request, or a combined ride hailing request and on-demand delivery request.

Clause 36: The method of any one of the preceding clauses, wherein the state of nearby vehicles characterizes attributes of the nearby vehicles and is determined using a state machine.

Clause 37: The method of any one of the preceding clauses, wherein the assignment of the respective nearby vehicle to the new request is based on an estimated time of arrival and available cargo space of the respective nearby vehicle.

Clause 38: The method of any one of the preceding clauses, wherein the decision criteria is based on a predefined time constraint applied to a proposed route associated with the new request.

Clause 39: The method of any one of the preceding clauses, wherein the decision criteria is based on a predefined time threshold applied to segments of a proposed route associated with the new request.

Clause 40: A system, comprising: at least one processor, and at least one non-transitory storage media storing instructions that, when executed by the at least one processor, cause the at least one processor to: identify a request type of a new request; determine a state of nearby vehicles, wherein the nearby vehicles are located within a predetermined radius around locations identified in the new request; evaluate an assignment of a respective nearby vehicle to the new request, wherein the assignment is evaluated according to decision criteria and the state of nearby vehicles; accept the assignment of the respective nearby vehicle to the new request when the decision criteria is satisfied; deny the assignment of the respective nearby vehicle to the new request when the decision criteria is not satisfied; and transmit the acceptance or denial of the new request to the respective nearby vehicle, wherein the respective nearby vehicle is configured to navigate routes associated with the new request.

Clause 41: The system of clause 40, wherein the request type is a ride hailing request, an on-demand delivery request, or a combined ride hailing request and on-demand delivery request.

Clause 42: The system of any one of the preceding clauses, wherein the state of nearby vehicles characterizes attributes of the nearby vehicles and is determined using a state machine.

Clause 43: The system of any one of the preceding clauses, wherein the assignment of the respective nearby vehicle to the new request is based on an estimated time of arrival and available cargo space of the respective nearby vehicle.

Clause 44: The system of any one of the preceding clauses, wherein the decision criteria is based on a predefined time constraint applied to a proposed route associated with the new request.

Clause 45: The system of any one of the preceding clauses, wherein the decision criteria is based on a predefined time threshold applied to segments of a proposed route associated with the new request.

Clause 46: At least one non-transitory storage media storing instructions that, when executed by at least one processor, cause the at least one processor to: identify a request type of a new request; determine a state of nearby vehicles, wherein the nearby vehicles are located within a predetermined radius around locations identified in the new request; evaluate an assignment of a respective nearby vehicle to the new request, wherein the assignment is evaluated according to decision criteria and the state of nearby vehicles; accept the assignment of the respective nearby vehicle to the new request when the decision criteria is satisfied; deny the assignment of the respective nearby vehicle to the new request when the decision criteria is not satisfied; and transmit the acceptance or denial of the new request to the respective nearby vehicle, wherein the respective nearby vehicle is configured to navigate routes associated with the new request.

Clause 47: The least one non-transitory storage media of clause 46, wherein the request type is a ride hailing request, an on-demand delivery request, or a combined ride hailing request and on-demand delivery request.

Clause 48: The least one non-transitory storage media of any one of the preceding clauses, wherein the state of nearby vehicles characterizes attributes of the nearby vehicles and is determined using a state machine.

Clause 49: The least one non-transitory storage media of any one of the preceding clauses, wherein the assignment of the respective nearby vehicle to the new request is based on an estimated time of arrival and available cargo space of the respective nearby vehicle.

Clause 50: The least one non-transitory storage media of any one of the preceding clauses, wherein the decision criteria is based on a predefined time constraint applied to a proposed route associated with the new request.

Clause 51: The least one non-transitory storage media of any one of the preceding clauses, wherein the decision criteria is based on a predefined time threshold applied to segments of a proposed route associated with the new request.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
assigning, using at least one processor, delivery locations of packages to areas of a predetermined map, wherein the areas segment the delivery locations according to accessibility types;
determining, using the at least one processor, an autonomous functionality of a vehicle for delivery of the packages within a respective area, wherein the autonomous functionality describes an autonomous capability of the vehicle;
generating, using the at least one processor, routes to deliver the packages using the autonomous functionality of the vehicle within the respective area; and
transmitting, using the at least one processor, the routes to the vehicle, wherein the vehicle is configured to navigate the routes to deliver the packages at the delivery locations.

2. The method of claim 1, wherein the delivery location is assigned to an area of a predetermined map based on the accessibility type and an accessibility sub-category.

3. The method of claim 1, wherein the autonomous functionality of the vehicle for delivery of the package includes the presence or lack of a delivery device.

4. The method of claim 1, wherein the respective area comprises delivery infrastructures and the autonomous functionality of the vehicle for delivery of the packages in the area is fully autonomous, without a human driver.

5. The method of claim 1, wherein the respective area is a robot deliverable area and the autonomous functionality of the vehicle for delivery of the packages in the area is fully autonomous, without a human driver.

6. The method of claim 5, wherein the autonomous functionality of the vehicle comprises a delivery device that enables autonomous final step delivery.

7. The method of claim 1, wherein the respective area is a robot cannot deliver area and the autonomous functionality of the vehicle for delivery of the packages in the area is fully autonomous, without a human driver.

8. The method of claim 1, wherein the respective area is a robot cannot deliver area and the autonomous functionality of the vehicle for delivery of the packages in the area is fully autonomous with a delivery worker that enables human supported final step delivery.

9. The method of claim 1, wherein the vehicle is a member of a ride hailing fleet, and the packages are delivered via trunk delivery.

10. The method of claim 1, wherein the vehicle is operable to navigate routes to deliver the packages at the delivery locations in a driverless shuttle mode, wherein a human delivery worker delivers packages from the vehicle to a respective delivery area.

11. The method of claim 1, wherein the vehicle is operable to navigate routes to deliver the packages at the delivery locations in a train mode, wherein the vehicle is one of a train of vehicles and a human delivery worker delivers packages from the train of vehicles to a respective delivery area.

12. A system, comprising:
at least one processor, and
at least one non-transitory storage media storing instructions that, when executed by the at least one processor, cause the at least one processor to:
assign delivery locations of packages to areas of a predetermined map, wherein the areas segment the delivery locations according to accessibility types;
determine an autonomous functionality of a vehicle for delivery of the packages within a respective area, wherein the autonomous functionality describes an autonomous capability of the vehicle;
generate routes to deliver the packages using the autonomous functionality of the vehicle within the respective area; and
transmit the routes to the vehicle, wherein the vehicle is configured to navigate the routes to deliver the packages at the delivery locations.

13. The system of claim 12, wherein the delivery location is assigned to an area of a predetermined map based on the accessibility type and an accessibility sub-category.

14. The system of claim 12, wherein the autonomous functionality of the vehicle for delivery of the package includes the presence or lack of a delivery device.

15. The system of claim 12, wherein the respective area comprises delivery infrastructures and the autonomous functionality of the vehicle for delivery of the packages in the area is fully autonomous, without a human driver.

16-22. canceled

23. At least one non-transitory storage media storing instructions that, when executed by at least one processor, cause the at least one processor to:
assign delivery locations of packages to areas of a predetermined map, wherein the areas segment the delivery locations according to accessibility types;
determine an autonomous functionality of a vehicle for delivery of the packages within a respective area, wherein the autonomous functionality describes an autonomous capability of the vehicle;
generate routes to deliver the packages using the autonomous functionality of the vehicle within the respective area; and
transmit the routes to the vehicle, wherein the vehicle is configured to navigate the routes to deliver the packages at the delivery locations.

24. The least one non-transitory storage media of claim 23, wherein the delivery location is assigned to an area of a predetermined map based on the accessibility type and an accessibility sub-category.

25. The least one non-transitory storage media of claim 23, wherein the autonomous functionality of the vehicle for delivery of the package includes the presence or lack of a delivery device.

26. The least one non-transitory storage media of claim 23, wherein the respective area comprises delivery infrastructures and the autonomous functionality of the vehicle for delivery of the packages in the area is fully autonomous, without a human driver.

27. The least one non-transitory storage media of claim 23, wherein the respective area is a robot deliverable area and the autonomous functionality of the vehicle for delivery of the packages in the area is fully autonomous, without a human driver.

28-51. canceled
